(19) United States
(12) Patent Application Publication
(10) Pub. No.: US 2013/0077554 A1
(43) Pub. Date: Mar. 28, 2013

(54) COMMON ANCHOR BASED AGGREGATION

(71) Applicant: INTERDIGITAL PATENT HOLDINGS, INC., Wilmington, DE (US)

(72) Inventors: Jean-Louis Gauvreau, Montreal (CA); Rocco Di Girolamo, Montreal (CA); Amith V. Chincholi, West Babylon, NY (US); Liangping Ma, San Diego, CA (US); Alpaslan Demir, East Meadow, NY (US)

(73) Assignee: INTERDIGITAL PATENT HOLDINGS, INC., Wilmington, DE (US)

(21) Appl. No.: 13/627,706

(22) Filed: Sep. 26, 2012

Related U.S. Application Data
(60) Provisional application No. 61/539,268, filed on Sep. 26, 2011.

(51) Int. Cl. H04W 72/04; H04W 4/06

(52) U.S. Cl. 370/312; 370/328; 370/329

(57) ABSTRACT

Embodiments contemplate techniques for managing aggregation between using an anchor channel over a first frequency band as the anchor band between an Access Point and a wireless receiver/transmitter unit (WTRU). One or more embodiments may include the WRTU receiving one or more beacons via the anchor channel, where the one or more beacons may provide allocation information for allocating a supplementary channel on a second frequency band as a supplementary band that may be different from the first frequency band. Embodiments also contemplate establishing the supplementary channel over the supplementary band using the allocation information provided in the one or more beacons. Embodiments also contemplate exchanging data over the established supplementary channel on the supplementary band.

### CROSS REFERENCE TO RELATED APPLICATIONS

This application claims the benefit of U.S. Provisional Patent Application No. 61/539,268, titled “Methods, Apparatus and Systems for Common Anchor Based Aggregation”, filed Sep. 26, 2011, the disclosure of which hereby incorporated by reference herein in its entirety, for all purposes.

### BACKGROUND OF THE INVENTION

The analog TV bands include the Very High Frequency (VHF) band and the Ultra High Frequency (UHF) band. The VHF is composed of the low VHF band operating from 54 MHz to 88 MHz (excluding 72 MHz to 76 MHz), and the high VHF band operating from 174 MHz to 216 MHz. The UHF band is composed of the low UHF band operating from 470 MHz to 698 MHz, and the high UHF band operating from 698 MHz to 806 MHz. Within the TV bands, each TV channel has 6 MHz bandwidth. Channels 2 to 6 are in the low VHF band; Channels 7 to 13 are in the high VHF band; Channels 14-51 are in the low UHF band; Channels 52 to 69 are in the high UHF band.

In the United States, the Federal Communications Commission (FCC) set Jun. 12, 2009 as the deadline for replacing analog TV broadcasting by digital TV broadcasting. The digital TV channel definitions are the same as the analog TV channel. The digital TV bands use analog TV channels 2 to 51 (except 37), while the analog TV channels 52 to 69 may be used for new non-broadcast users. The frequency allocated to a broadcasting service but not used locally is called White Space (WS). The TVWS refers to the TV channels 2 to 51 (except 37).

Besides TV signals, there are other licensed signals transmitted on the TV bands. Channel 37 is reserved for radio astronomy and Wireless Medical Telemetry Service (WMTS), where the latter may operate on any vacant TV channels 7 to 46. Private Land Mobile Radio System (PLMRS) uses channels 14 to 20 in certain metropolitan areas. Remote control devices use any channels above channel 4, except channel 37. The starting frequency of FM channel 200 is 87.9 MHz, with partial overlapping on TV channel 6. The wireless microphone uses channels 2 to 51 with a bandwidth of 200 kHz. The FCC has ruled that the wireless microphone usage is restricted to two pre-specified channels, and its operation on other channels requires a pre-registry.

Because of the transition from analog to digital TV transmissions in the 470-862 MHz frequency band, certain portions of the spectrum are no longer used for TV transmissions, though the amount and exact frequency of unused spectrum varies from location to location. The FCC has opened up these TVWS frequencies for a variety of unlicensed uses.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the disclosure are directed to methods, systems and apparatus for managing aggregation between an access point (AP) and a Wireless Receiver/Transmitter Unit (WRTU) using an anchor channel over a first frequency band between the AP and the WRTU. One representative method may include wirelessly receiving, by the WRTU, one or more beacons via the anchor channel, the one or more beacons providing allocation information for allocating a supplementary channel on a second frequency band, as a supplementary band, different from the first frequency band; establishing the supplementary channel over the supplementary band using the allocation information provided in the one or more beacons; and wirelessly exchanging, by the WRTU, data over the established supplementary channel on the supplementary band.

In one or more embodiments, the wirelessly exchanging of the data over the established supplementary channel may include one of: (1) wirelessly sending the data over the established supplementary channel; (2) wirelessly receiving the data over the established supplementary channel or (3) wirelessly sending and receiving data over the established supplementary channel.

In one or more embodiments, the wirelessly receiving of the one or more beacons via the anchor channel may include receiving a series of beacons, each beacon including control information for the anchor channel and control information for the supplementary channel.

In one or more embodiments, the wirelessly receiving of the one or more beacons via the anchor channel may include receiving a series of beacons, a first portion of the series of beacons including control information for the anchor channel and a second portion of the series of beacons including control information for the supplementary channel.

In one or more embodiments, the series of beacons may be received in each beacon transmission interval such that the first beacon in each beacon transmission interval may be broadcast and other respective beacons in each beacon transmission interval may be multicast.

In one or more embodiments, the series of beacons may be periodically received such that the first beacon associated with the anchor channel may be broadcast and other respective beacons associated with the supplementary channels may be multicast.

In one or more embodiments, the WRTU may determine which of the series of beacons are the beacons that include the control information for the supplementary channel based on a predetermined number of beacon intervals and may search for the control information in the determined beacons.

In one or more embodiments, the wirelessly receiving of the one or more beacons via the anchor channel may include providing allocation information for allocating at least one further supplementary channel on the second frequency band or a further frequency band,

In one or more embodiments, the further supplementary channel may be established using the allocation information provided by the one or more beacons; and the WRTU may wirelessly exchange further data over the further supplementary channel.

In one or more embodiments, the wirelessly exchanging of the data over the established supplementary channel and the further data over the further supplementary channel may include one of: (1) wirelessly sending the data over the established supplementary channel and wirelessly receiving the further data over the established further supplementary channel; (2) wirelessly receiving the data over the established supplementary channel and wireless sending the further data over the established further supplementary channel; (3) wirelessly sending the data and the further data over the established supplementary channel and the established further supplementary channel; or (4) wirelessly receiving the data and the further data over the established supplementary channel and the established further supplementary channel.

In one or more embodiments, the WRTU may: (A) determine from the control information in the second portion of the series of beacons whether to modify channel allocation for sending/receiving data on at least one of: (1) the supplementary channel; or (2) the further supplementary channel, (B) change, based on the control information in each beacon of the second portion of beacons, an allocation on the supplementary channel to provide one of: (1) an uplink only channel on the supplementary channel; or (2) a downlink only channel on the supplementary channel; and (C) change, based on the control information in each beacon of the second portion of the beacons, an allocation on the further supplementary channel to provide one of: (1) an uplink only channel on the further supplementary channel; or (2) a downlink only channel on the further supplementary channel.

In one or more embodiments, the anchor channel and one channel of the supplementary channel and further supplementary channel may be switched, responsive to the one channel having less beacon losses relative to the anchor channel such that the one channel becomes a new anchor channel and the previous anchor channel becomes one of the supplementary channels.

In one or more embodiments, the anchor channel may be in an ISM band and the supplementary channel may be in a TVWS band.

In one or more embodiments, the beacons that include the allocation information for the supplementary channel may include quieting information indicating one or more quiet periods for quieting the WRTU.

In one or more embodiments, the WRTU may determine the quieting information from the beacons, and may restrict transmissions during the quiet periods to enable a search for other transmissions on the TVWS band.

In one or more embodiments, the WRTU may receive one or more beacons indicating updated allocation information to move the WRTU from the supplementary channel, responsive to finding other transmissions on the TVWS band.

In one or more embodiments, the allocation information in the beacons sent over on the anchor channel may include operating information regarding the supplementary channel associated with at least one of: (1) an association procedure; or (2) a discovery procedure.

In one or more embodiments, the wirelessly receiving of the one or more beacons via the anchor channel may include detecting at least one beacon in a beacon portion that is associated with control information indicating the allocation information for the anchor channel, and detecting a beacon in a payload portion of the frame used for data exchange on the anchor channel, the beacons detected in the payload portion indicating the allocation information for the supplementary channel.

In one or more embodiments, the WRTU may detect the allocation information from the received one or more beacons that may include determining at least one of: (1) a usage mode of the supplementary channel; (2) activation or deactivation of the supplementary channel; (3) a traffic indication map indicating whether the WRTU is scheduled for uplink or downlink transmission on the supplementary channel before the next beacon interval; (4) a resource sharing map indicating whether the WRTU is restricted from using the supplementary channel for the current beacon interval; (5) dynamic spectrum management information indicating at least one of (i) a quieting period during which the WRTU is restricted from transmitting over the supplementary channel, (ii) transmitted power limits for the supplementary channel, or (iii) coexistence information; (5) a channel switch announcement; and/or (6) a beacon interval number identifying a particular beacon interval.

In one or more embodiments, the WRTU may send a request including capability information indicating the capability of the WRTU to use the supplementary channel or further supplementary channels.

In one or more embodiments, the WRTU may receive via the anchor channel, at least one of: a scaling factor indicating a channel synchronization relative to the anchor channel or a secondary channel sync signal in a management frame on the anchor channel.

In one or more embodiments, the WRTU may receive via the supplementary channel, frames including data; and may send via the anchor channel, a block acknowledgement for the frames received on the supplementary channel.

In one or more embodiments, the sending of the block acknowledgement for the frames received on the supplementary channel may be sent responsive to expiration of a timer or the initiation of a subsequent beacon interval.

In one or more embodiments, the sending of the block acknowledgement for the frames received on the supplementary channel may be sent when a time since reception of the oldest unacknowledged frame exceeds a threshold.

In one or more embodiments, the WRTU may receive a broadcast acknowledgement query on the anchor channel to initiate a block acknowledgment response, and responsive to reception of the broadcast acknowledgement query, the block acknowledgement on the anchor channel for the frames received on the supplementary channel may be sent.

In one or more embodiments, the WRTU may determine whether predetermined portions used for data exchange on the anchor channel are available for acknowledgements; and may insert the block acknowledgment into one of the predetermined portions that is available for acknowledgements such that the sending of the block acknowledgement for the frames received on the supplementary channel may include sending the frame that includes the inserted block acknowledgment.

In one or more embodiments, the supplementary channel may be allocated based on one of: (1) a fixed reservation-access scheme in which the supplementary channel is shared between or among the plurality of WRTUs in a fixed round-robin manner; (2) a demand reservation-based access scheme in which the anchor channel is used as a reservation channel; or (3) a contention access scheme in which each WRTU follows pre-existing rules for sensing the supplementary channel and transmits if the supplementary channel is sensed to be free for a threshold period.

Another representative method may include wirelessly transmitting, by the AP, one or more beacons via the anchor channel, the one or more beacons providing allocation information for allocating a supplementary channel on a second frequency band, as a supplementary band, different from the first frequency band; establishing the supplementary channel over the supplementary band using the allocation information provided by the one or more beacons; and wirelessly exchanging, by the AP, data over the established supplementary channel on the supplementary band.

In one or more embodiments, the AP may determine which of the series of beacons are the beacons that are to include the control information for the supplementary channel based on a predetermined number of beacon intervals; and may insert the control information in the determined beacons.

In one or more embodiments, the AP may determine whether to modify one or more channel allocations for exchanging data on the supplementary and further supplementary channels; may insert into the second portion of the series of beacons control information to allocate the supplementary channel as one of: (1) as an uplink only channel; or (2) a downlink only channel; may insert into the second portion of the series of beacons, control information to allocate the further supplementary channel as one of: (1) as an uplink only channel; or (2) a downlink only channel; and may send the series of beacons on the anchor channel.

In one or more embodiments, the beacons that include the allocation information of the supplementary channel further may include quieting information indicating one or more quiet periods for quieting the WRTU.

In one or more embodiments, the AP may determine during the one or more quiet periods, whether transmissions are present on the TVWS band, as a determined result; and may send to the WRTU, updated allocation information, responsive to the determined result.

In one or more embodiments, the AP may receive a message including capability information indicating the capability of the WRTU to use the supplementary channel or further supplementary channels; may determine an allocation of at least one of: (1) the supplementary channel or (2) the further supplementary channels for the WRTU in accordance with the received capability information; and may insert the allocation information corresponding to the determined allocation for the WRTU in the series of beacons destined for the WRTU.

A representative Wireless Receiver/Transmitter Unit (WRTU) may include a wireless receiver/transmitter configured to wirelessly receive one or more beacons via the anchor channel, the one or more beacons providing allocation information for allocating of a supplementary channel on a second frequency band, as a supplementary band, different from a first frequency band; and a processor in conjunction with the wireless receiver/transmitter configured to establish the supplementary channel over the supplementary band using the allocation information provided by the one or more beacons.

In one or more embodiments, the wireless receiver/transmitter wirelessly may exchange data over the established supplementary channel on the supplementary band.

In one or more embodiments, a MAC layer may aggregate the flows over the anchor and supplementary channels.

One or more embodiments contemplate a wireless access point that may include a wireless receiver/transmitter configured to wirelessly transmit one or more beacons via the anchor channel, the one or more beacons providing allocation information for allocating a supplementary channel on a second frequency band, as a supplementary band, different from a first frequency band; and a processor in conjunction with the wireless receiver/transmitter configured to establish the supplementary channel over the supplementary band using the allocation information provided by the one or more beacons.

### BRIEF DESCRIPTION OF THE DRAWINGS

A more detailed understanding may be had from the Detailed Description below, given by way of example in conjunction with drawings appended hereto. Figures in such drawings, like the detailed description, are examples. As such, the Figures and the detailed description are not to be considered limiting, and other equally effective examples are contemplated, wherein:

FIG. 1 is a diagram illustrating exemplary TV band spectrum usage in the United States consistent with embodiments;

FIG. 2A is a diagram illustrating a representative communication system in which one or more disclosed embodiments may be implemented;

FIG. 2B is a diagram illustrating a representative wireless transmit/receive unit (WRTU) that may be used within the communication system illustrated in FIG. 2A;

FIGS. 2C, 2D, and 2E are system diagrams of representative radio access networks and representative core networks that may be used within the communication system illustrated in FIGS. 1A, 2A and/or 2B;

FIG. 3A is a diagram illustrating a representative system deploying core network based access technologies and Internet-based access technologies consistent with embodiments;

FIG. 3B is a diagram illustrating a representative system deploying supplementary carriers in an opportunistic fashion consistent with embodiments;

FIG. 4 is a diagram illustrating exemplary carrier aggregation using a representative anchor channel and multiple supplementary channels consistent with embodiments;

FIG. 5 is a diagram illustrating exemplary communication over the anchor channel and supplementary channels of FIG. 4 consistent with embodiments;

FIG. 6 is a diagram illustrating a representative frame structure consistent with embodiments;

FIG. 7 is a diagram illustrating an exemplary carrier aggregation procedure consistent with embodiments;

FIG. 8 is a diagram illustrating an exemplary SuppChan sync sent on the anchor channel consistent with embodiments;

FIG. 9 is a diagram illustrating a representative transmission operation on an anchor channel and a supplementary channel consistent with embodiments;

FIG. 10 is a diagram illustrating another representative transmission operation on the anchor channel and supplementary channel consistent with embodiments;

FIG. 11 is a diagram illustrating a representative acknowledgment procedure consistent with embodiments;

FIG. 12 is a diagram illustrating another representative acknowledgment procedure consistent with embodiments;

FIG. 13 is a diagram illustrating a further representative acknowledgment procedure consistent with embodiments;

FIG. 14 is a diagram illustrating an additional representative acknowledgement procedure consistent with embodiments;

FIG. 15 is a diagram illustrating an additional representative acknowledgement procedure consistent with embodiments;

FIG. 16 is a diagram illustrating a representative AP coverage area using a plurality of supplementary channels/carriers consistent with embodiments;

FIG. 17A is a diagram illustrating an exemplary coverage area change when changing channels from TVWS to ISM band consistent with embodiments;

FIG. 17B is a diagram illustrating an exemplary coverage area change when changing channels from ISM band to TVWS band consistent with embodiments;

FIG. 18 is a block diagram illustrating a representative transceiver architecture for inter-band MAC-layer aggregation using multiple radio front-ends consistent with embodiments;

FIG. 19 is a block diagram illustrating another representative transceiver architecture consistent with embodiments; and

FIG. 20 is a block diagram illustrating another representative transceiver architecture consistent with embodiments.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. As used herein, the article “a” or “an”, absent further qualification or characterization, may be understood to mean “one or more” or “at least one”, for example.

The FCC may allow unlicensed radio transmitters to operate on the TVWS except channels 3, 4 and 37, as long as minimum interference is caused to the licensed radio transmissions. The operation of unlicensed radio transmitters may satisfy several restrictions. Embodiments recognize at least three kinds of unlicensed TV Band Devices (TVBDs): (1) fixed TVBD; (2) mode I portable (or personal) TVBD and (3) mode II portable (or personal) TVBD. Both fixed TVBD and mode II portable TVBD may have geo-location database access capability and may register to the TV band database. Access to the TV band database may be obtained by querying the allowed TV channels to avoid interference with digital TV signals and licensed signals transmitted on the TV bands. Spectrum sensing may be considered as an add-on feature for TVBDs to enable low interference to be caused to digital TV signals and licensed signals. Sensing-only TVBDs may be allowed to operate on TVWS perhaps if their access to the TV band database is limited or restricted.

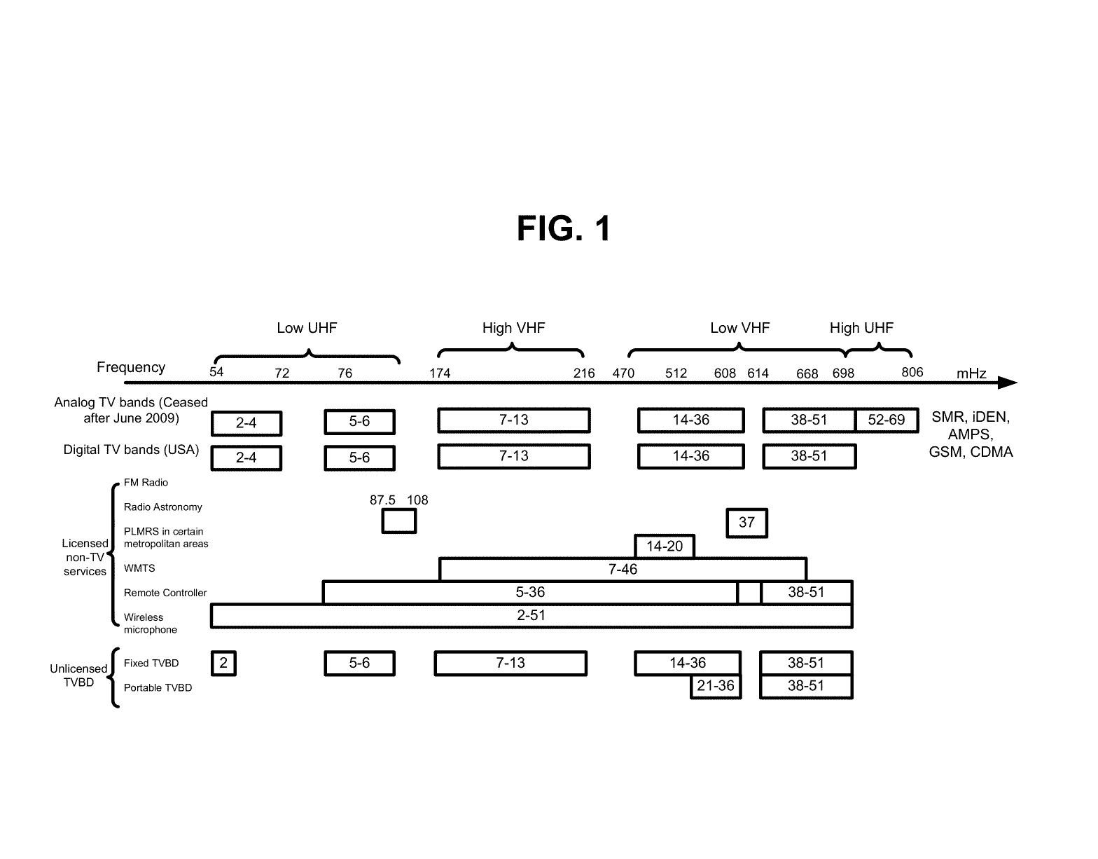

FIG. 1 shows the TV band spectrum usage. Embodiments recognize that fixed TVBDs may operate on channels 2 to 51, perhaps except channels 3, 4, 37, and they may not operate on the same or the first adjacent channel to a channel used by TV services. The maximum transmission power of fixed TVBD may be 1 W, with at most 6 dBi antenna gain. The maximum Effective Isotropic Radiated Power (EIRP) may be 4 W. A portable TVBD may only operate on channels 21 to 51, perhaps except channel 37, and may not operate on the same channel used by TV services. The maximum transmission power of portable TVBD may be 100 mW or 40 mW if it is on the first adjacent channel to a channel used by TV services. If a TVBD device is a sensing-only device, then its transmission power may not exceed 50 mW. Some or all of the TVBDs may have strict out-of-band emissions. The antenna (outdoor) height of a fixed TVBD may be less than 30 meters, while there may not be any limitation on the antenna height for portable TVBD.

Embodiments contemplate that the opportunistic use of White Space, for example, in the 470-790 MHz bands may be used by secondary users for any radio communication (e.g., if the use does not interfere with other incumbent/primary users). As a result, the use of LTE and other cellular technologies within the TVWS bands may enable carrier aggregation. Current wireless networks may be reaching their limits in terms of maximum throughput offered. These networks are typically designed for targeted applications (for example, voice, video and/or data, among others) and for an envisioned load. Embodiments recognize that wireless networks continue to evolve, for example, wireless local area networks (WLANs) may be used for streaming video and for providing hotspot coverage (e.g., in coffee shops and other public areas), and cellular networks may be used for web browsing. Certain businesses may use WLANs and forego wiring Ethernet for the simplicity of wireless connectivity. Certain residential homes and other entities may have at least one WiFi access point.

Wireless networks have relied on using their spectrum more efficiently. In one or more embodiments, carrier aggregation may be used to aggregate transmission over multiple chunks of spectrum. Spectrum may be available in many bands including licensed bands and/or License Exempt (LE) bands (e.g. ISM bands, TVWS bands, and/or 60 GHz bands, among others). The TVWS band is a generic name that may be used to represent spectrum in the UHF and VHF bands that is not reserved (e.g., for TV distribution, for wireless microphone use, or for other reserved use).

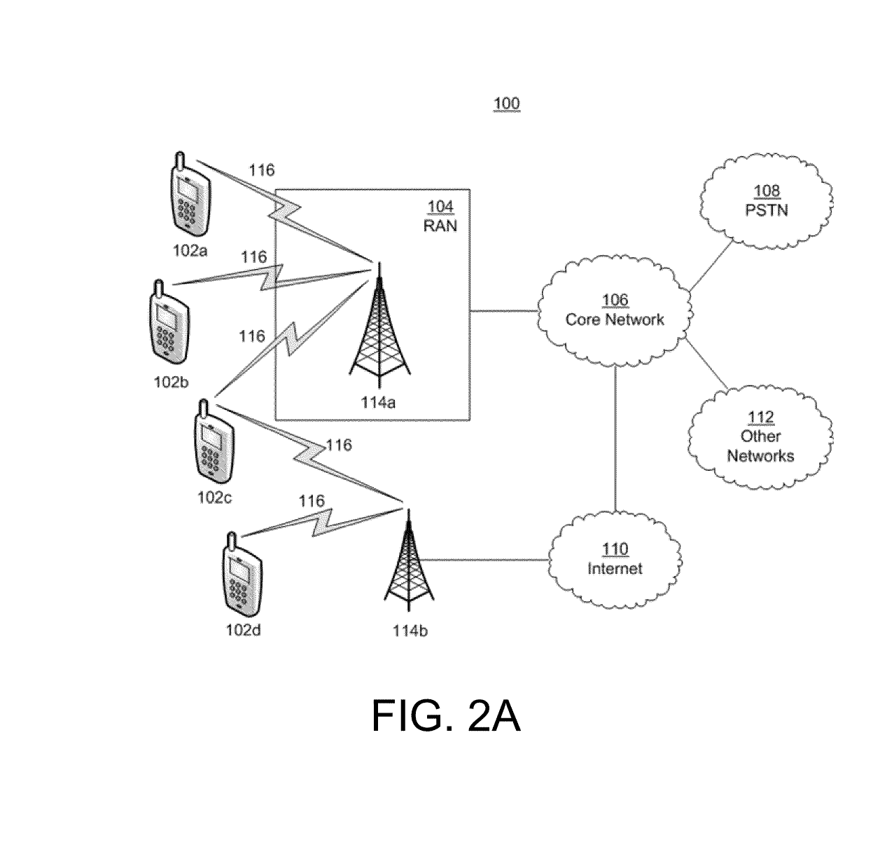

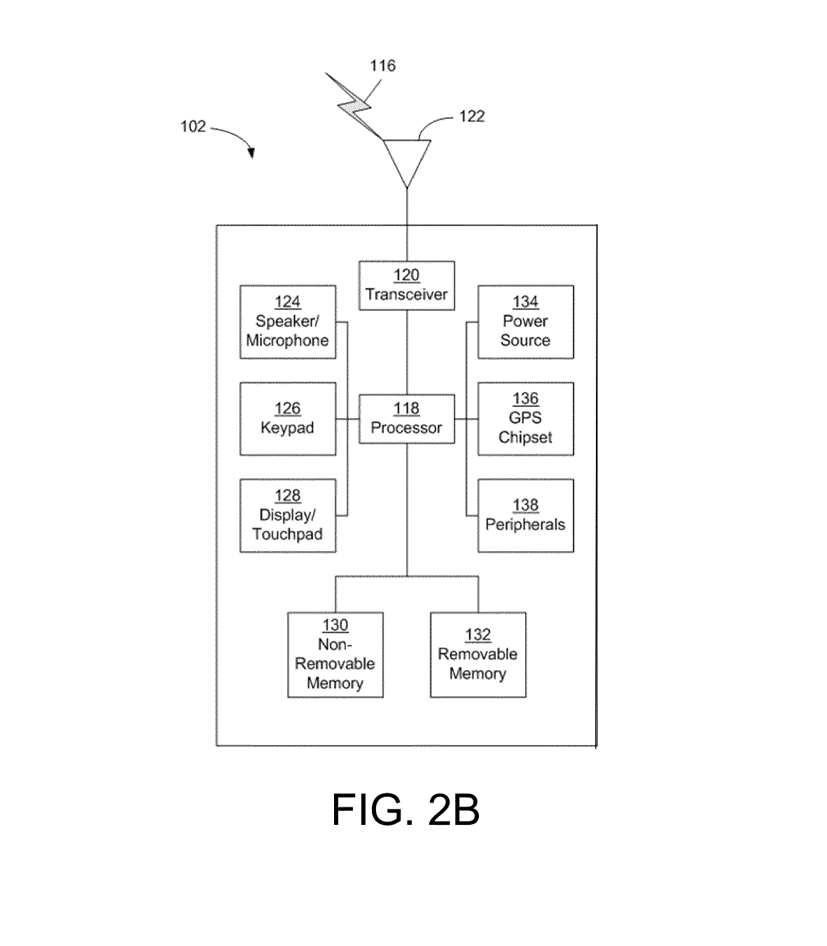

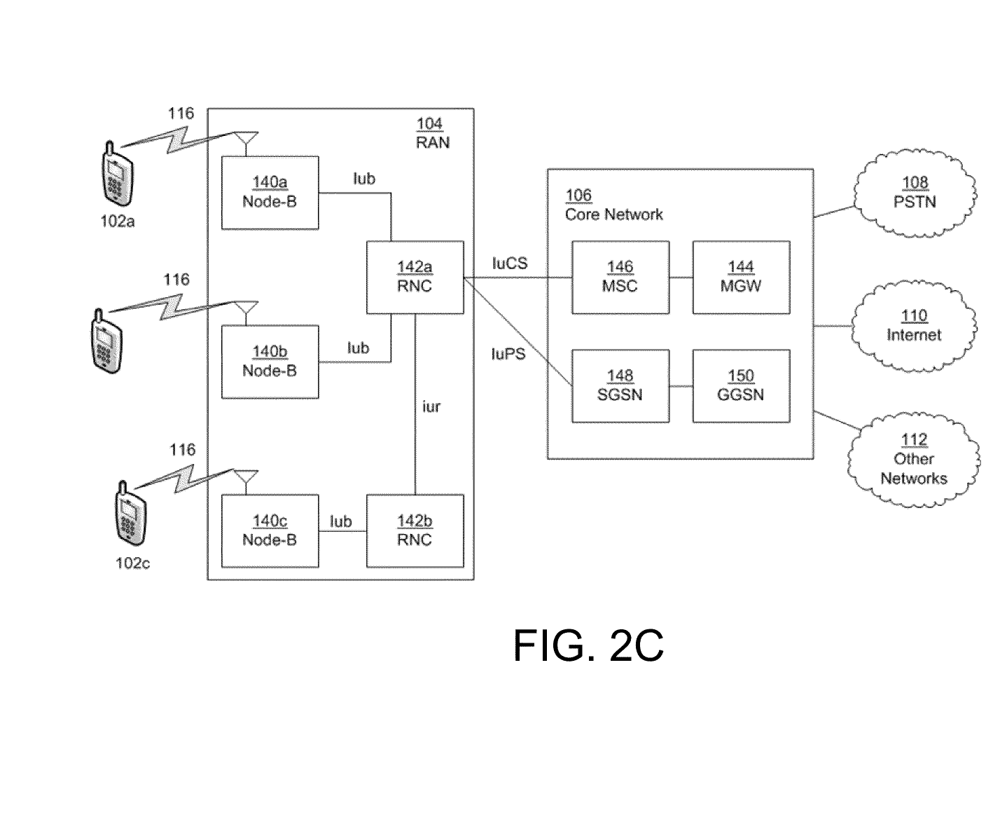

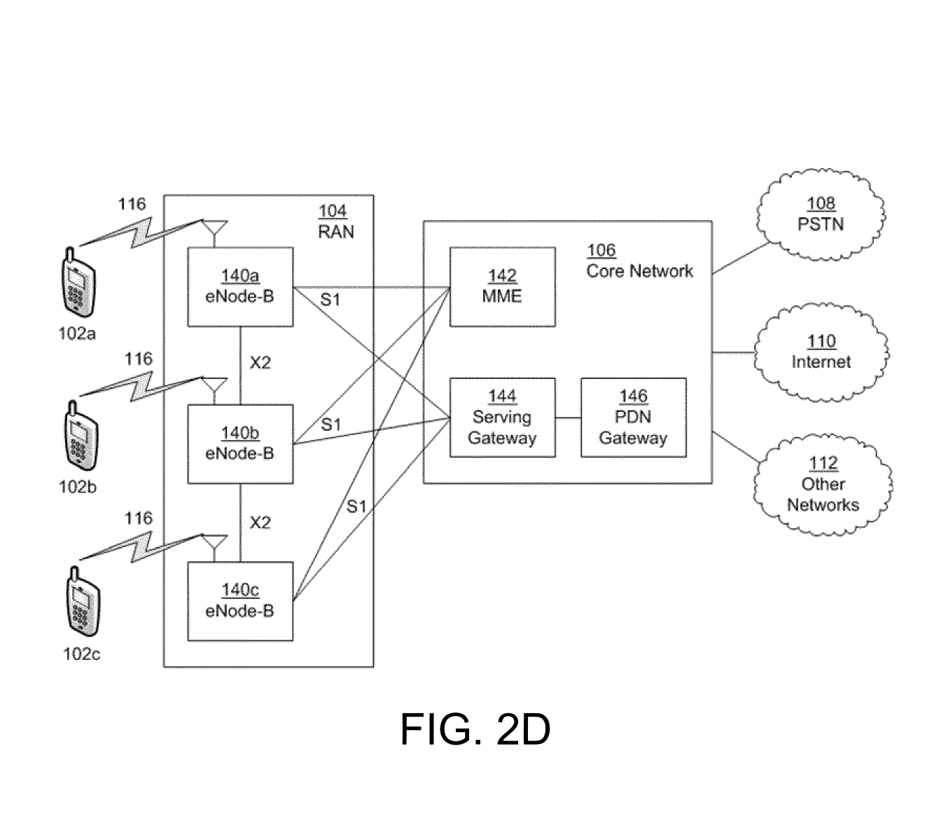

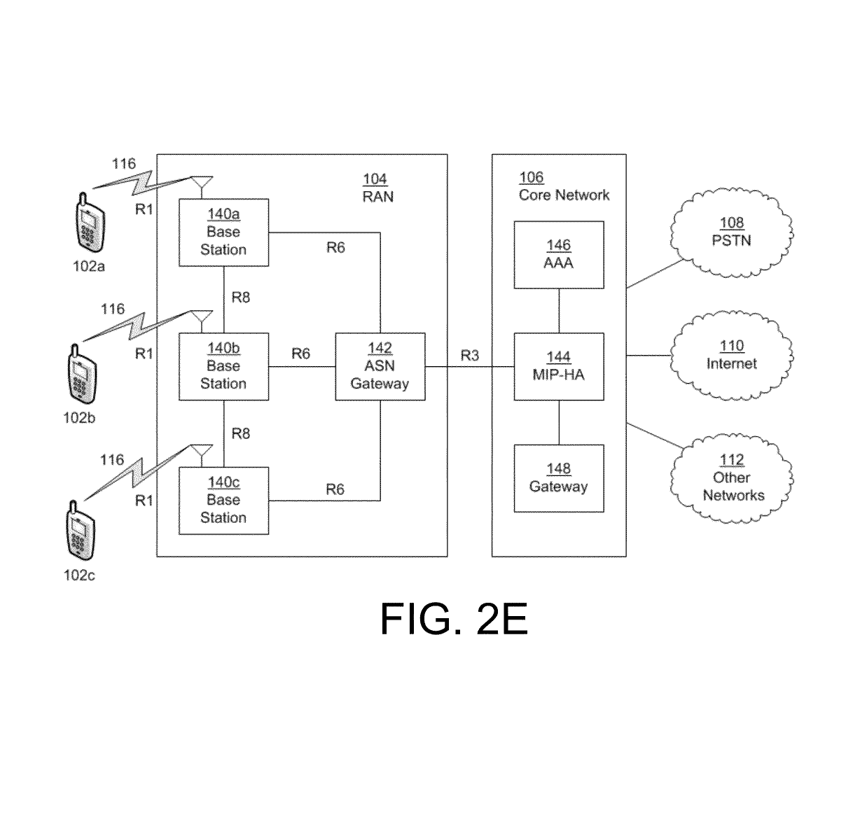

FIG. 2A is a diagram of a representative communications system 100 in which one or more disclosed embodiments may be implemented. The communications system 100 may be a multiple access system that provides content, such as, data, video, messaging, broadcast, etc., to multiple wireless users. The communications system 100 may enable multiple users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 2A, the communication system 100 may include wireless transmit/receive units (WRTUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WRTUs, base stations, networks, and/or network elements. Each of the WRTUs 102a, 102b, 102c, 102d may be any type of device configured to operate and/or communicate in a wireless environment. By way of example, the WRTUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communication systems 100 may also include a base station 114a and a base station 114b. Each of the base stations 114a, 114b may be any type of device configured to wirelessly interface with at least one of the WRTUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WRTUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communication system 100 may be a multiple access system and may employ one or more channel access schemes, such as CDMA, TDMA, FDMA, OFDMA, SC-FDMA, and the like. For example, the base station 114a in the RAN 104 and the WRTUs 102a, 102b, 102c may implement a radio technology such as Universal Mobile Telecommunication System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WRTUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WRTUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 2A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WRTUs 102c, 102d may implement a radio technology such as IEEE 802.11 to establish a wireless local area network (WLAN). In another embodiment, the base station 114b and the WRTUs 102c, 102d may implement a radio technology such as IEEE 802.15 to establish a wireless personal area network (WPAN). In yet another embodiment, the base station 114b and the WRTUs 102c, 102d may utilize a cellular-based RAT (e.g., WCDMA, CDMA2000, GSM, LTE, LTE-A, etc.) to establish a picocell or femtocell. As shown in FIG. 2A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WRTUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 2A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WRTUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WRTUs 102a, 102b, 102c, 102d in the communication system 100 may include multi-mode capabilities, i.e., the WRTUs 102a, 102b, 102c, 102d may include multiple transceivers for communicating with different wireless networks over different wireless links. For example, the WRTU 102c shown in FIG. 2A may be configured to communicate with the base station 114a, which may employ a cellular-based radio technology, and with the base station 114b, which may employ an IEEE 802 radio technology.

FIG. 2B is a system diagram of a representative WRTU 102. As shown in FIG. 2B, the WRTU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WRTU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WRTU 102 to operate in a wireless environment. The processor 118 may be coupled to the transceiver 120, which may be coupled to the transmit/receive element 122. While FIG. 2B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 2B as a single element, the WRTU 102 may include any number of transmit/receive elements 122. More specifically, the WRTU 102 may employ MIMO technology. Thus, in one embodiment, the WRTU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WRTU 102 may have multi-mode capabilities. Thus, the transceiver 120 may include multiple transceivers for enabling the WRTU 102 to communicate via multiple RATs, such as UTRA and IEEE 802.11, for example.

The processor 118 of the WRTU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WRTU 102, such as on a server or a home computer (not shown).

The processor 118 may receive power from the power source 134, and may be configured to distribute and/or control the power to the other components in the WRTU 102. The power source 134 may be any suitable device for powering the WRTU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WRTU 102. In addition to, or in lieu of, the information from the GPS chipset 136, the WRTU 102 may receive location information over the air interface 116 from a base station (e.g., base stations 114a, 114b) and/or determine its location based on the timing of the signals being received from two or more nearby base stations. It will be appreciated that the WRTU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 2C is a system diagram of the RAN 104 and the core network 106 according to an embodiment. As noted above, the RAN 104 may employ a UTRA radio technology to communicate with the WRTUs 102a, 102b, and 102c over the air interface 116. The RAN 104 may also be in communication with the core network 106. As shown in FIG. 2C, the RAN 104 may include Node-Bs 140a, 140b, 140c, which may each include one or more transceivers for communicating with the WRTUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 2C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 2C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WRTUs 102a, 102b, 102c with access to circuit-switched networks, such as the PSTN 108, to facilitate communications between the WRTUs 102a, 102b, and 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WRTUs 102a, 102b, 102c with access to packet-switched networks, such as the Internet 110, to facilitate communications between and the WRTUs 102a, 102b, 102c and IP-enabled devices.

As noted above, the core network 106 may also be connected to the networks 112, which may include other wired or wireless networks that are owned and/or operated by other service providers.

FIG. 2D is a system diagram of the RAN 104 and the core network 106 according to another embodiment. As noted above, the RAN 104 may employ an E-UTRA radio technology to communicate with the WRTUs 102a, 102b, and 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WRTUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WRTU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 2D, the eNode-Bs 160a, 160b, 160c may communicate with one another over an X2 interface.

The core network 106 shown in FIG. 2D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WRTUs 102a, 102b, 102c, bearer activation/deactivation, selecting a particular serving gateway during an initial attach of the WRTUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WRTUs 102a, 102b, 102c. The serving gateway 164 may also perform other functions, such as anchoring user planes during inter-eNode B handovers, triggering paging when downlink data is available for the WRTUs 102a, 102b, 102c, managing and storing contexts of the WRTUs 102a, 102b, 102c, and the like.

The serving gateway 164 may also be connected to the PDN gateway 166, which may provide the WRTUs 102a, 102b, 102c with access to packet-switched networks, such as the Internet 110, to facilitate communications between the WRTUs 102a, 102b, and 102c and IP-enabled devices.

The core network 106 may facilitate communications with other networks. For example, the core network 106 may provide the WRTUs 102a, 102b, 102c with access to circuit-switched networks, such as the PSTN 108, to facilitate communications between the WRTUs 102a, 102b, and 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WRTUs 102a, 102b, 102c with access to the networks 112, which may include other wired or wireless networks that are owned and/or operated by other service providers.

FIG. 2E is a system diagram of the RAN 104 and the core network 106 according to another embodiment. The RAN 104 may be an access service network (ASN) that employs IEEE 802.16 radio technology to communicate with the WRTUs 102a, 102b, and 102c over the air interface 116. As will be further discussed below, the communication links between the different functional entities of the WRTUs 102a, 102b, 102c, the RAN 104, and the core network 106 may be defined as reference points.

As shown in FIG. 2E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WRTUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WRTU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WRTUs 102a, 102b, 102c and the RAN 104 may be defined as an R1 reference point that implements the IEEE 802.16 specification. In addition, each of the WRTUs 102a, 102b, and 102c may establish a logical interface (not shown) with the core network 106. The logical interface between the WRTUs 102a, 102b, 102c and the core network 106 may be defined as an R2 reference point, which may be used for authentication, authorization, IP host configuration management, and/or mobility management.

The communication link between each of the base stations 170a, 170b, and 170c may be defined as an R8 reference point that includes protocols for facilitating WRTU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WRTUs 102a, 102b, 100c.

As shown in FIG. 2E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WRTUs 102a, 102b, and 102c to roam between different ASNs and/or different core networks. The MIP-HA 174 may provide the WRTUs 102a, 102b, 102c with access to packet-switched networks, such as the Internet 110, to facilitate communications between the WRTUs 102a, 102b, and 102c and IP-enabled devices. The AAA server 176 may be responsible for user authentication and for supporting user services. The gateway 178 may facilitate interworking with other networks. For example, the gateway 178 may provide the WRTUs 102a, 102b, 102c with access to circuit-switched networks, such as the PSTN 108, to facilitate communications between the WRTUs 102a, 102b, and 102c and traditional land-line communications devices. In addition, the gateway 178 may provide the WRTUs 102a, 102b, 102c with access to the networks 112, which may include other wired or wireless networks that are owned and/or operated by other service providers.

Although not shown in FIG. 2E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WRTUs 102a, 102b, 102c between the RAN 104 and the other ASNs. The communication link between the core network 106 and the other core networks may be defined as an R5 reference, which may include protocols for facilitating interworking between home core networks and visited core networks.

A mobile user may choose from a wide range of technologies to access networks such as GPRS, EDGE, 3G and/or 4G for wide area access, and/or WiFi for local area access. Mobile hosts may be multi-homed (e.g., connected via multiple access technologies and/or multi-access points) and may possess two or more heterogeneous interfaces. Internet content may be distributed (e.g., over a “cloud”) such that content delivery may become more complex (e.g., to get the right content from the right location).

In one or more embodiments, a multi-homed wireless device (e.g., a mobile host, mobile device, netbook and/or UE, among others) may access or receive (e.g., efficiently access or receive) content (e.g., internet-based content).

In one or more embodiments, a multi-homed mobile host may use (e.g., may fully utilize) a subset or all of the available interfaces (e.g., wireless and/or wired) to send content or to receive content (e.g., efficiently receive content).

Although the receiver is described in FIGS. 2A-2E as a wireless terminal, it is contemplated that in one or more embodiments that such a terminal may use wired communication interfaces with the communication network.

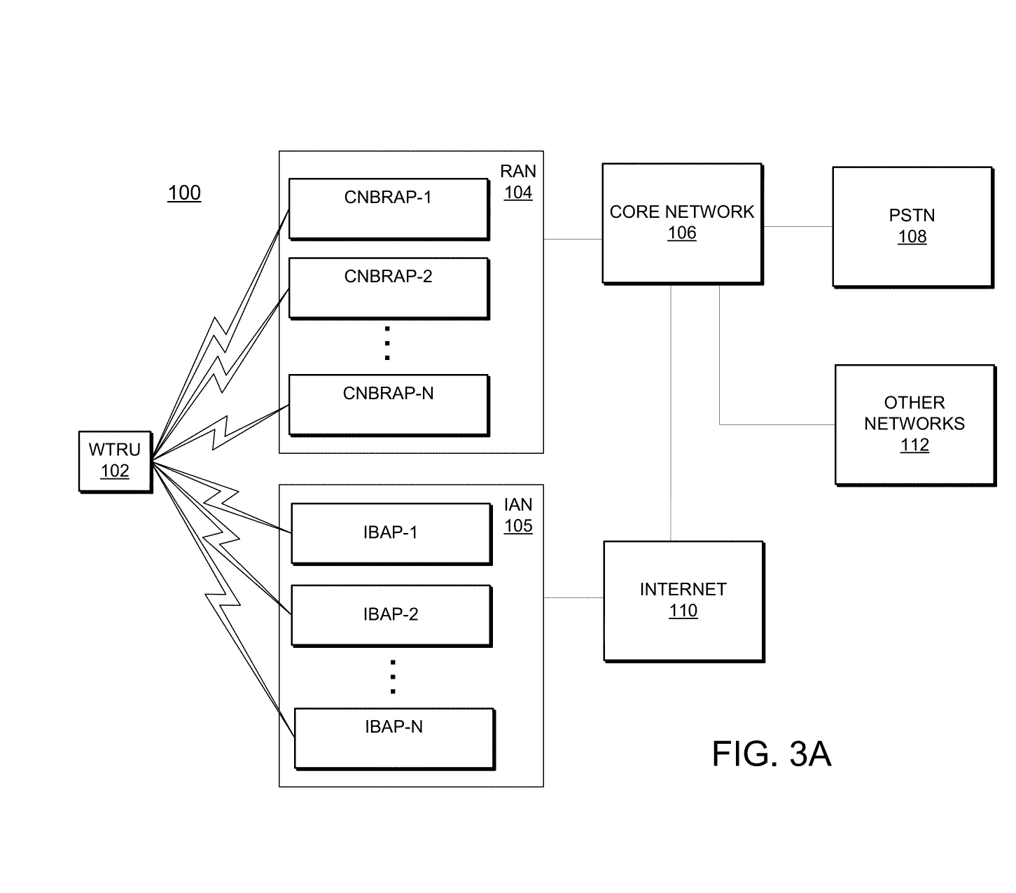

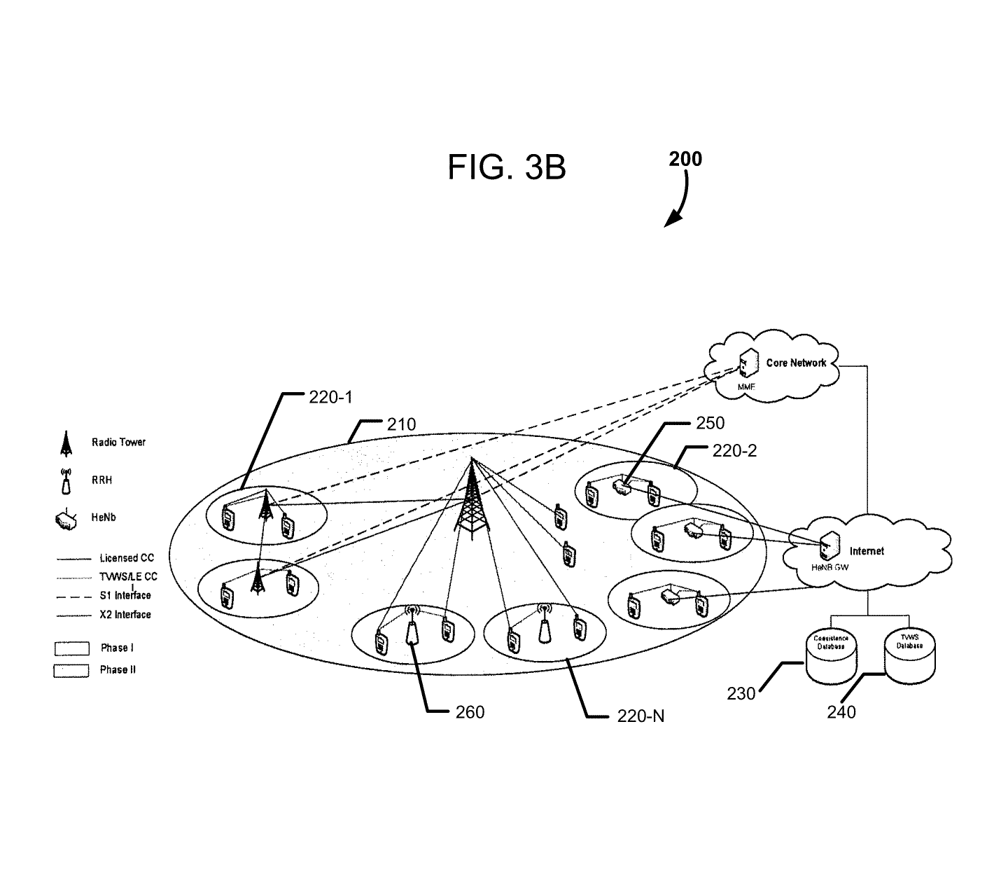

FIG. 3A is a diagram that illustrates a representative system deploying core network based access technologies and Internet-based access technologies.

Referring to FIG. 3A, representative system 100 may include RAN 104, internet access network (IAN) 105, core network 106, PSTN 108, Internet 110, and other networks 112. System 100 may communicate with WRTU 102 via communications links (e.g., wireless interfaces or wired interfaces) through the RAN 104 to the core network 106 or the IAN 105 to the Internet 110. The RAN 104 may include one or more core network based radio access technologies (e.g., with one or a plurality of core network based radio access points CNBRAP-1, CNRBRAP-2, . . . CNBRAP-N). The IAN 104 may include one or more internet based access technologies (e.g., with one or a plurality of internet based access points IBAP-1, IBAP-2, . . . IBAP-N). The core network 106 may also interface with the PSTN 108, the Internet 110 and/or the other networks 112. System 100 may enable carrier aggregation of supplementary carriers with, for example, a WiFi, an 802.11 or WLAN anchor carrier in, for example, the ISM band.

In one or more embodiments, one or more of the CNBRAPs may be access points using the TVWS band and/or one or more of the IBAPs may be WiFi, 802.11 or WLAN access points using the ISM band.

In one or more embodiments, channels associated with license exempt frequencies or licensed frequencies may be aggregated with frequencies used for operation of WiFi, 802.11 or WLAN access points.

FIG. 3B shows an exemplary system 200 deploying supplementary carriers in an opportunistic fashion to use Licensed Exempt (LE) bands (e.g., TVWS and ISM) contemplated by embodiments. The system may use heterogeneous network deployments that may make use of advanced LE carrier aggregation solutions to provide hot-spot coverage. The heterogeneous network architecture may include, for example an LTE macro cell 210 and underlay of pico/femto/RRH cells 220-1, 220-2 . . . 220-N that may aggregate licensed and LE bands. The macro cells 210 may provide service continuity. The pico/femto cells 220-1, 220-2 . . . 220-N may be used to provide hot spot coverage. A coexistence database 230 and mechanisms to coordinate operation with other secondary networks/users operating in LE bands may be implemented. A TVWS database 240 may be used to protect incumbent users operating in the TVWS band. There may be infrastructure to support dynamic spectrum trading across both licensed and LE bands. The infrastructure may include IBAPs 250 (e.g., HeNBs, WiFi APs, 802.11 APs and/or WLAN APs) communicating via the Internet to enable carrier aggregation of spectrum from licensed exempt bands and the bands associated with the IBAPs 250 using, for example, the ISM band. For example, channels in the ISM bands and/or licensed frequency bands may be aggregated with channels in another frequency band (e.g., a licensed exempt TVWS band) for carrier aggregation.

Although carrier aggregation has been discussed with respect to license exempt TVWS bands, it is contemplated that other frequency bands (e.g., licensed band) may also be aggregated with ISM bands for carrier aggregation.

Wireless systems following the 802.11 standards may use a carrier sense multiple access with collision avoidance (CSMA/CA) scheme. The CSMA/CA may be enhanced with a virtual carrier sense mechanism that may use Request to Send (RTS) and Clear to Send (CTS) control frames to reserve the channel for a period of time. Successfully received packets may be acknowledged through an ACK control frame. A station (STA) or access point (AP) may maintain a timer for each transmitted frame. If the ACK is not received before expiration of the timer, among other contemplated conditions, the frame may be retransmitted, and the retransmissions may continue until a maximum number of retransmissions is exceeded, after which the frame may be discarded.

APs (e.g., 802.11 APs) may broadcast beacons that may be used for discovery, and may provide network information to the STAs (or UEs or WTRUs). The STAs (or UEs or WTRUs) may passively scan for broadcast beacons. After broadcasted beacons are found, the STAs (or UEs or WTRUs) may associate with the AP, and adjust their timing to the timing of the beacon signal. For example, in 802.11 based networks, frame synchronization at the STAs may be achieved by monitoring the beacons transmitted by the APs. The beacons may be sent periodically (e.g., at a nominal rate), and may include a timestamp information element, which may be used by the STAs to update their local clocks. In one or more embodiments described herein, the term beacon may refer to an 802.11 beacon, a modified 802.11 beacon to support supplementary channels, and/or more generally to a special management frame that may include information to allow operation over supplementary channels.

The beacons may be used to support devices in one or more power save modes. An AP may periodically or at predetermined times send a Traffic Indication Map (TIM), for example within a beacon, to identify which STAs using a power saving mode have data frames waiting for them (cached) in the AP's buffer. The TIM may identify each respective STA by an association ID that the AP assigned during the association procedure.

Anchor channels generally refer to channels that may support existing or legacy communication. One or more supplementary channels in the same or other frequency bands, using the same or different underlying radio access technology, may be aggregated to a respective anchor channel. The supplementary channel may increase system capacity, address potential bottlenecks, and/or reduce latency. The supplementary channel may not be a fully-backward compatible channel, and as a result may not be in operation alone without a corresponding anchor channel. For example, the supplementary channel may be linked to an anchor carrier such that: (1) a wireless transmit/receive device (WTRU or user equipment (UE)) or cellular device may not be able to camp on a cell using (or perhaps in some embodiments only using) a supplementary channel; and/or (2) the WLAN STAs may not be able to associate with an AP using (or perhaps in some embodiments only using) a supplementary channel.

Although an anchor channel is shown using an 802.11 WiFi radio access technology (RAT), it is contemplated that other RATs may be implemented. In one or more embodiments, the anchor channel and the supplementary channel may be associated with a number of different frequency or spectrum bands including an anchor carrier that may use TVWS.

In one or more embodiments, a WLAN may include: (1) an anchor channel using an ISM band and a supplementary channel using a TVWS band; (2) the anchor channel using the TVWS band and the supplementary channel using the ISM band or the same or a different TVWS band.

A legacy STA (LS) may generally refer to an 802.11 or other STA that may not or perhaps does not support inter-band carrier aggregation.

An inter-band (IB) STA may general refer to an 802.11 STA that may or does support inter-band carrier aggregation.

An anchor channel may generally refer to a channel that may support communication with one or more legacy STAs.

A supplementary channel may generally refer to a channel that may be aggregated with a corresponding anchor channel, and that in one or more embodiments may rely on the anchor channel for one or more procedures (e.g. discovery procedures, association procedures, and/or beaconing procedures) and/or may provide optimized data transfer on the supplementary channel.

An uplink (UL) transmission may generally refer to a transmission from the STAs to or towards the AP and a downlink (DL) transmission may generally refer to a transmission from the AP to or towards the STAs.

One or more embodiments contemplate inter-band aggregation or band aggregation of non-contiguous bands, for example, interband aggregation between ISM channels and/or one or more non-contiguous TVWS channels.

In one or more embodiments, the inter-band aggregation may include the TVWS band having particular operating procedures and may include: (1) scheduling procedures (e.g., that schedule traffic across the aggregated bands); (2) discovery procedures (e.g., that run in both bands); beaconing procedures (that run in both bands); and/or (3) adaptation procedures (that provide for a fast changing environment), among others.

In one or more embodiments, an anchor channel using 802.11 technologies may be used to support one or more supplementary channels in the LE band.

In one or more embodiments, the anchor channel in one band (e.g. LE spectrum) may be deployed or used to support supplementary channels in the same or a different band. The anchor channel may carry: (1) common scheduling information; (2) frame synchronization information; (3) transmission feedback information; (4) channel change reconfiguration information; (5) mobility management related procedures or information; and/or (6) supplementary channel configuration information, for example pertinent to channels operating over multiple bands. The LE spectrum may be any LE band, for example ISM bands, the TVWS band, sub 1 GHz bands that may be used for 802.11ah deployments or may be any licensed band which may be leased out (e.g., brokered) for a pre-specified duration for secondary use by other technologies such as 802.11.

The 802.11 STAs may operate using multiple channels across one or multiple bands and may use the anchor channel to send or to receive: (1) configuration information; (2) synchronization information; (3) scheduling information; and/or (4) feedback information associated with the supplementary channels.

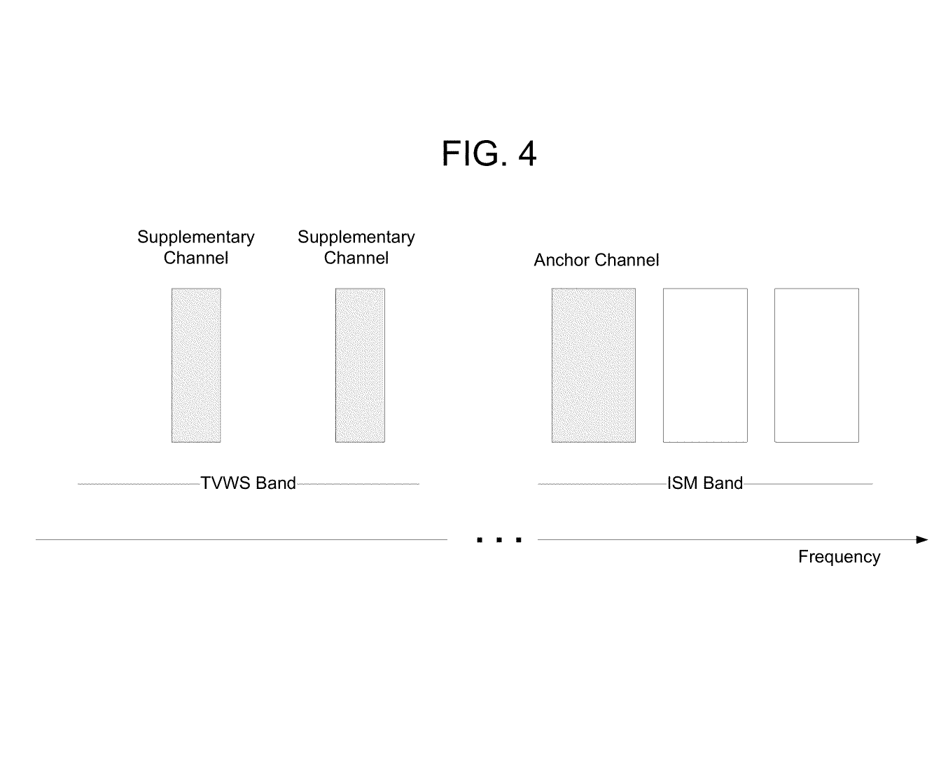

FIG. 4 is a diagram illustrating carrier aggregation using a representative anchor channel and multiple supplementary channels.

Referring to FIG. 4, the anchor carrier may use or be within the ISM bands and the supplementary carrier may use or be within the TVWS band. The bandwidth of the supplementary carriers may or may not be the same and the rate supported by the supplementary carriers may be the same or different between or among supplementary carriers. It is contemplated that the technology used in the supplementary channel may or may not be the same as that used in the anchor channel.

Although a single supplementary channel is generally described, it is contemplated that any number of supplementary channels may be used and may extend the bandwidth available relative to a single supplementary channel. For example, in one or more embodiments, a plurality of supplementary channels may be aggregated with one or more anchor channels.

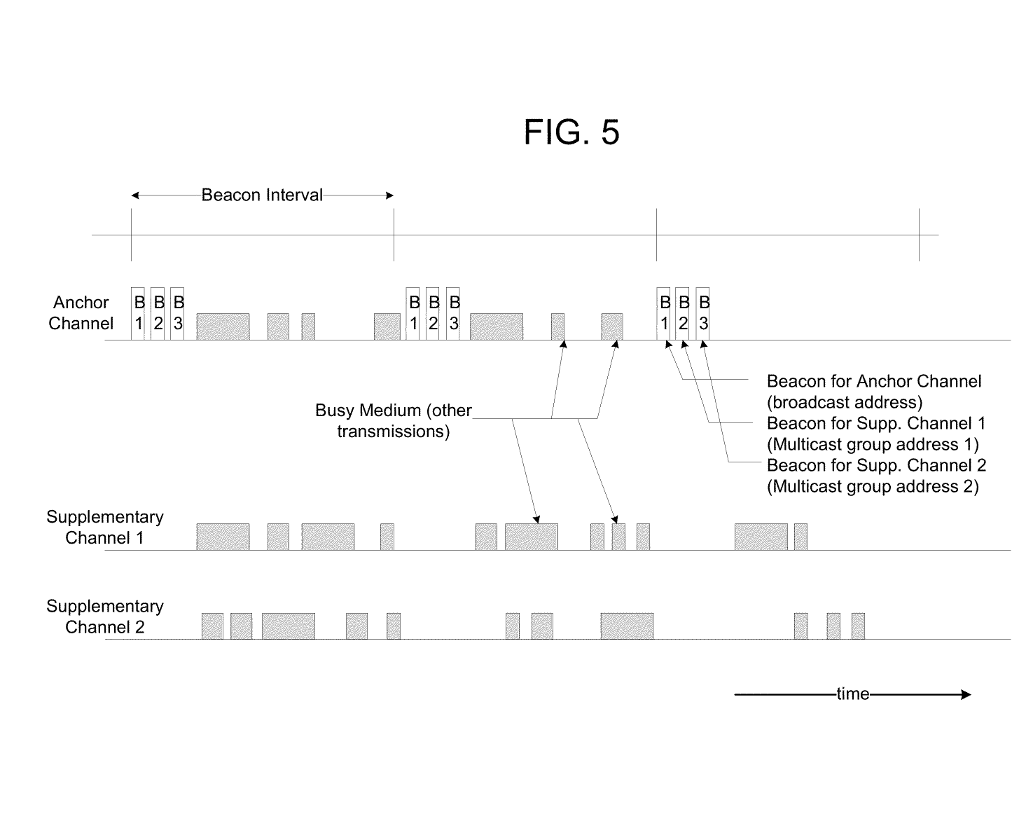

FIG. 5 is an exemplary timing diagram illustrating communication over the anchor channel and supplementary channels of FIG. 4 contemplated by one or more embodiments.

Referring to FIG. 5, an AP may send or transmit, via an anchor channel (e.g., in the anchor band), management frames or beacons b1, b2 and b3 that may be used for both the anchor channel and one or more supplementary channels. The STA may use or continue to use the anchor channel for the signaling (e.g., management and/or control information from the STA) related to, for example: (1) association procedures; (2) disassociation procedures; (3) reassociation procedures; (4) authentication procedures; (5) deauthentication procedures; and/or (6) discovery procedures (e.g., beaconing and/or probing), among others. For example, the control information may be provided over the anchor channel from the AP in a granted time slot after a corresponding set of beacons in a beacon interval. After the supplementary channel 1 and supplementary channel 2 are established or aggregated with the anchor channel, the STA may exchange data with the AP over the anchor channel, the supplementary channel 1 and/or the supplementary channel 2. For example, as shown in FIG. 5, data may be split between the anchor channel and the supplementary channel 1.

In one or more embodiments, the anchor channel may repeat the beacons B1, B2 and B3 at some or at each beacon interval. The supplementary channels may not include some or any beacons and may include frames of data (or perhaps in some embodiments may only include such frames) (e.g., exclusive of management and/or control information). In some embodiments, the management and/or control information may instead be sent over the anchor channel.

In one or more embodiments, the STA may provide this management and/or control signaling on a primary supplementary channel.

The beacons B1, B2 and B3 may include operating details, information and/or parameters of the channels, and may be configured for or tailored to different types of channels or individual channels (e.g., first and second types of channels may have different beacons or beacon structures, for example TVWS channels may have a first beacon structure and ISM channels may have a second, different beacon structure). The beacons may be adapted to the capability of the AP associated with the channels.

In one or more embodiments, the AP may periodically or at designated periods send beacons (e.g., k beacons such as B1, B2, Bk where some or each beacon may correspond to a supplementary channel) at or after the Target Beacon Transmission Times (TBTTs) or beacon interval. Beacon B1 associated with the primary or anchor channel may be transmitted to a broadcast address, whereas the beacons B2 and B3 associated with or for the supplementary channels may be transmitted to pre-defined multicast-group addresses. By sending the beacons B2 and B3 to pre-defined multicast-group addresses, among other contemplated techniques, legacy STAs may avoid unnecessarily dealing with such beacon frames. The periodicity or timing of the beacon transmissions for the supplementary channels may not be the same as the periodicity or timing for the anchor channel. For instance, if the operating conditions of the supplementary channel 1 do not change frequently (within a threshold period), beacon B2 may be sent once each N TBTT or beacon interval, where N may be an integer number.

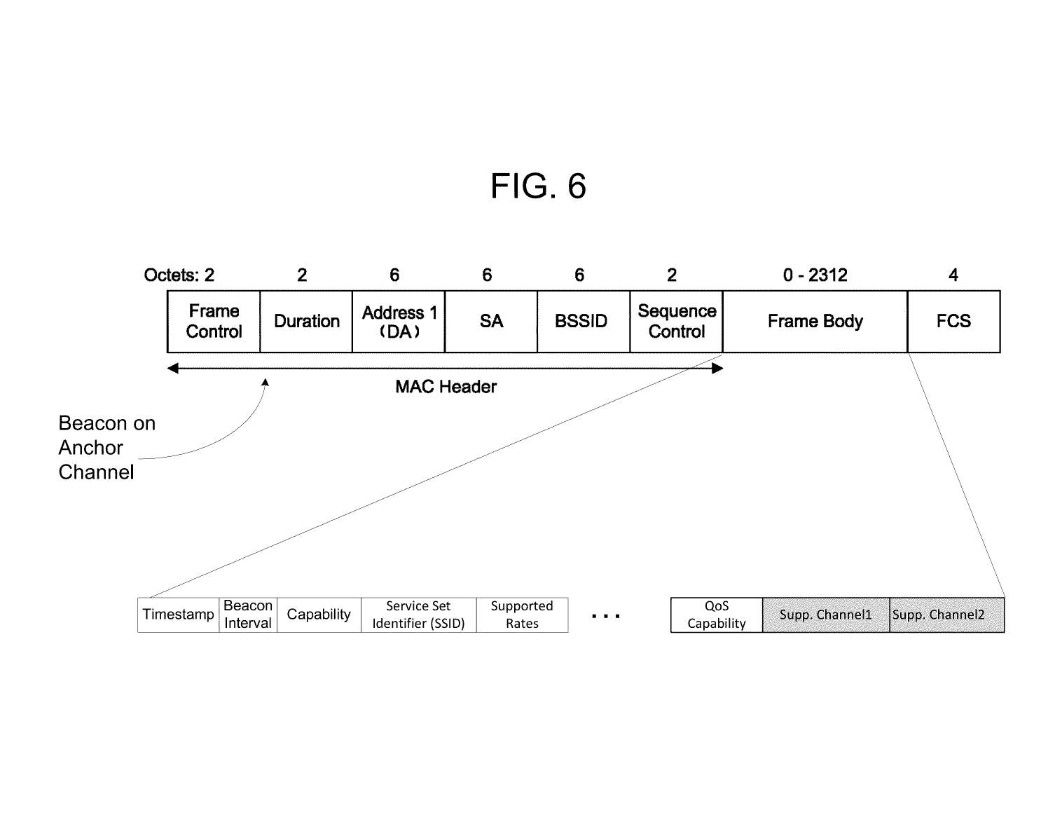

FIG. 6 is a diagram illustrating an exemplary frame structure sent from an AP.

Referring to FIG. 6, the beacon frame structure may include a MAC header portion, frame body, and/or a frame check sequence (FCS). The beacon may include a frame control field, a duration field, an address field (e.g., destination address field), a source address field, a basic service set identifier (BSSID) field, and/or a sequence control field, among others. The frame body may include control/management type information including a timestamp, the beacon interval, a capabilities field, a service set identifier (SSID), supported rates, a QoS capability, and/or the information for the supplementary channels (e.g., supplementary channel 1 and supplementary channel 2), among others.

For example, the operating details or information for the supplementary channels may be carried as additional information elements (IEs) in the anchor channel beacon. The beacon may use the broadcast address and be received by both legacy STAs and inter-band STAs. In one or more embodiments, the new information elements may be ignored by legacy STAs. In some embodiments, the use of the additional supplementary channel operating details or information may increase the size of the beacon.

In either one or more contemplated beacon structures associated with each supplementary channel or one or more contemplated information elements in the anchor channel beacon that may be associated with the supplementary channels, the supplementary channel operating details or information may be provided to the inter-band UEs and may include one or more of:
(1) the usage mode of the supplementary channel such as details or information of how the UE may use the supplementary channel;
   (For example, various alternatives are described in subsequent embodiments. For some or each of the usage modes, the AP may provide details or information related to: (i) the duration of the usage mode; (ii) where and/or how acknowledgements may to be transmitted for data sent on the supplementary channel; and/or (iii) inter-frame spacing to be used on the supplementary channel, among others.)
(2) Activation/Deactivation of the supplementary channel;
   (For example, this mechanism may allow the AP to activate and deactivate a supplementary channel at the granularity of a beacon interval.)
(3) Traffic Indication Map (TIM) associated with the supplementary channels such that the TIM may be modified to signal future activity on the supplementary channels;
   (For example, the AP may signal the STAs that may be scheduled (e.g., for uplink transmission or for downlink transmission) on the supplementary channel before the next TBTT. Upon reception of the TIM that indicates that a STA may not be scheduled, the STA may deactivate the supplementary channel until the next TBTT. For instance, the STA may stop monitoring the channel for any downlink traffic. In one implementation, the STA may receive both the TIM from the anchor channel (used to indicate to STAs in power save mode that there is traffic pending at the AP) as well as a TIM for each of the supplementary channels. The TIM for a supplementary channel may carry scheduling activity until the next beacon. If no activity is scheduled, the STA may deactivate the supplementary channel.)
(4) Resource Sharing Map (RSM); and/or
   (The format of the RSM may be similar to the TIM and may provide an indication of the STAs that may be allowed to use the supplementary channel for the current beacon interval. For example, new beacon information may indicate a list or table of association IDs that may use a given supplementary channel. STAs which are not part of the list or table may or may not be allowed to contend for access via the respective supplementary channel until the next beacon interval (e.g., at least the next beacon interval, and may use the indication to deactivate the channel.)
(5) Dynamic Spectrum Management (DSM) information.
   For example, the DSM information may include information particular to the band carrying the supplementary channel. For example, for the TVWS band, the AP may provide information related to: (i) measurements (type and/or frequency of measurements, and/or reporting of the measurements); (ii) quieting periods (e.g., one or more periods during which the STA may not transmit over the supplementary channel to allow sensing by the AP (e.g., to potentially detect the arrival of a primary user of the channel); (iii) channel information (such as the frequency and/or bandwidth of the supplementary channel). If the bandwidth or channel aggregation uses a set of supplementary channels, the channel information may refer to a set of carriers; (iv) transmitted power regulation and/or limits for one or more supplementary channels; (v) coexistence information such as information to allow coexistence across systems. For example, TVWS database information regarding primary usage information and/or location information associated with the primary usage; (vi) a channel switch announcement; (vii) beacon interval numbers (BINs). For example, the AP may send a BIN to identify a particular beacon interval. The BIN may be in addition to or in lieu of a sequence number that may be carried in the header of the beacon frames. Unlike the sequence number which may be incremented for management frames (e.g., all management frames), QoS data frames (e.g., with a broadcast/multicast address in the Address 1 field), and/or non-QoS data frames (e.g., all non-QoS data frames), the BIN may be incremented (e.g., only incremented) for beacon frames to allow the AP to schedule specific actions to occur in a specific future beacon interval. For instance, the BINs may be used for certain types of usage modes. In one or more embodiments, the beacon interval number may be set by a modulo-K counter (e.g., K=4096).

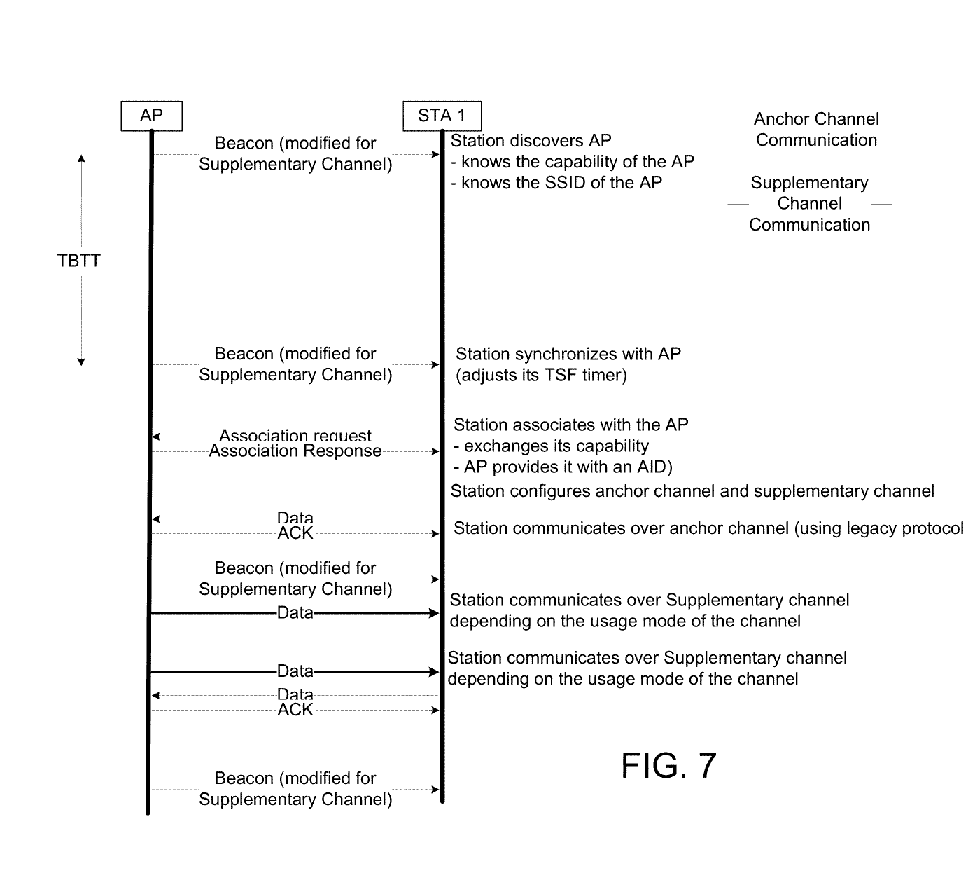

FIG. 7 is a diagram illustrating an example carrier aggregation technique. Referring to FIG. 7, in one or more embodiments, the AP may send one or more beacons that may be modified to include control information for the supplementary channel. The one or more beacons may be sent over the anchor channel. STA 1 may discover the AP by searching for beacons. The STA 1 may determine from the beacons the capability of the AP, the SSID of the AP, and/or the beacon interval or Target Beacon Transmit Time (TBTT). The AP may send a second beacon at the next TBTT. The STA 1 may synchronize with the AP by adjusting its timing synchronization function (TSF) timer. The STA 1 may send an Association Request to the AP to initiate an Association between the STA 1 and AP. The AP may send an Association Response including the AP's capabilities and its association identifier (AID). The STA1 may configure its anchor channel and supplementary channel or channels. The STA 1 may communicate over the anchor channel (e.g., send data over the anchor channel to the AP using a legacy protocol). The AP may send an acknowledgment message to the STA 1 regarding the data communicated. A further beacon may be sent from the AP after a second beacon interval. The further beacon may also be modified for the supplementary channel or channels and may provide the same or a different allocation of supplementary channels to the STA 1. The AP may also send or exchange data with the STA 1. The exchange of data between the AP and STA 1 may be based on the usage mode of the supplementary channels 1 and 2. For example, the supplementary channels may be used in a DL only, UL only or bidirectional mode. The STA 1 may also send data on the anchor channel and may receive an acknowledgment message from the AP. The procedure for associating the supplementary channels with the anchor channel may be dynamic and may occur during each beacon or set of beacons that are associated with a respective beacon interval.

The STA may use (or perhaps in some embodiments perhaps rely on) the anchor channel beacon for discovery and/or synchronization. A STA may search for the anchor channel beacon (or send a probe request on the anchor channel). After discovery of the AP, the inter-band STAs may synchronize with the beacon and/or may read the beacon information to determine the AP capability over the anchor channel and over any aggregated supplementary channels. The inter-band STAs may associate with the AP, providing details or information of its own capabilities.

In one or more embodiments, the Association Request (AR) frame may be modified to include a new Information field “Supplementary Channel Capability,” which may provide an indication of the supplementary channels supported by the STA, the measurement capabilities of the STA, and/or any specific usage modes supported by the STA. The AP may respond with an AR frame that may assign the STA a unique Association Identifier (AID). The STA may communicate with the AP using the anchor channel and/or the agreed usage mode on the supplementary channels.

In one or more embodiments, if the anchor channel uses its own timing, among other contemplated conditions, the anchor channel may assist the supplementary channel by including a scaling factor in the supplementary channel information element (IE) and/or in the supplementary channel beacon.

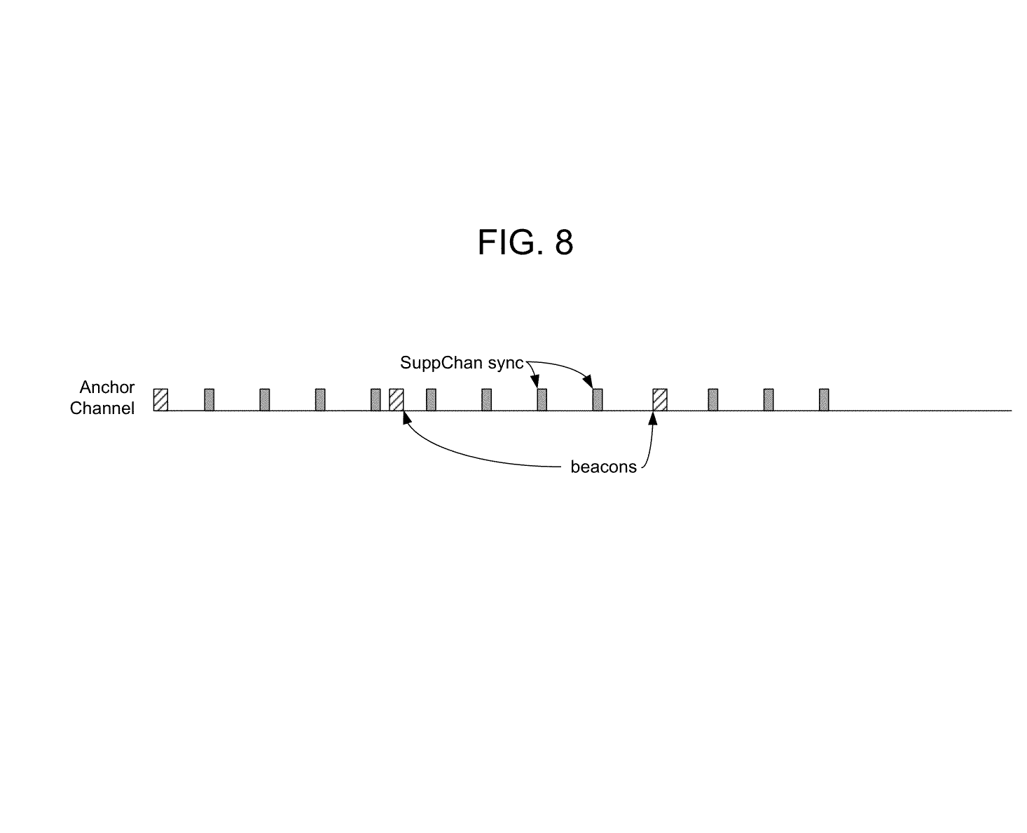

FIG. 8 is a diagram illustrating an exemplary SuppChan sync sent on the anchor channel.

Referring to FIG. 8, the anchor channel may transmit one or more secondary channel sync (e.g., SuppChan Sync) signals as specified management frames, for example, on the anchor channel. These specified management frames may have a higher priority to reduce their transmission latency and provide synchronization timing information for the allocated supplementary channels.

In one or more embodiments, the AP may relax its segregation of management frames to the anchor channel by allowing certain management frames (e.g., ACTION management frames) to be transmitted on both the anchor channel and the supplementary channel or channels.

It is contemplated in one or more embodiments that if the supplementary channel is shared with competing systems (e.g., 802.11, LTE, and/or WPAN, among others) then a coexistence mechanism may be used. In one or more embodiments, a coexistence management frame (CMF) may periodically or at pre-established times be transmitted (e.g., similar to or the same as a beacon) using or over the supplementary channel. The CMF may have a very long period (e.g., greater than a threshold time period) in the order of K beacon intervals (K>1) and may include limited information (e.g., service set identifier (SSID) and/or usage mode). Other 802.11 networks may be able to identify and interpret the CMF and execute a coexistence procedure to allow a sharing of the supplementary channel or to enable the other 802.11 networks to use an alternate channel.

In one or more embodiments, if the system uses communication over one or more supplementary channels, the AP may send beamforming vector identifier information and/or beamforming sector identifier information to the STA's. It is contemplated in one or more embodiments that the AP may determine or know the STA's location information or sector ID in which the STA is located. When the supplementary channel is allocated for UL transmission, among other contemplated conditions, the allocation information may allow the STA to avoid scanning the spatial region to look for or detect appropriate beam pattern to communicate with the AP. When the supplementary channel is allocated for DL transmission, among other contemplated conditions, the AP may communicate the spatial precoding information to the STA. The spatial precoding information may be carried in the Association Response message sent to the STA using or over the anchor channel.

In one or more embodiments, the supplementary channel and anchor channel may maintain the same frame synchronization and/or may rely on or may continue to rely on the beacon transmissions on the anchor channel. The STA operating in both bands may maintain timestamps (e.g., a single series of timestamps for synchronizing both the anchor channel and the supplementary channel). Respective timestamps or each timestamp may be derived from the information carried in an anchor channel beacon.

In one or more embodiments, beacon information may not be carried in the supplementary channels. The STAs communicating using or over the supplementary carriers may communicate or continue to communicate during the target beacon transmission times (TBTTs). A STA may determine whether to delay acting on any information included in the beacon carried on the anchor carrier, until after completion of any ongoing transmission or transmission opportunity (TXOP) on the supplementary channel.

In one or more embodiments, the STA may terminate the ongoing transmission or TXOP if the anchor frame beacon requests a specific action. Representative examples of different types of specific action may include those that may affect the TVWS band channels (e.g., a channel switch announcement or start of a quiet period). In other representative embodiments, the STA may send messages indicating when (e.g., may specifically be told when) to act on information included in the anchor carrier beacon (for instance, act on such information in K TBTTs).

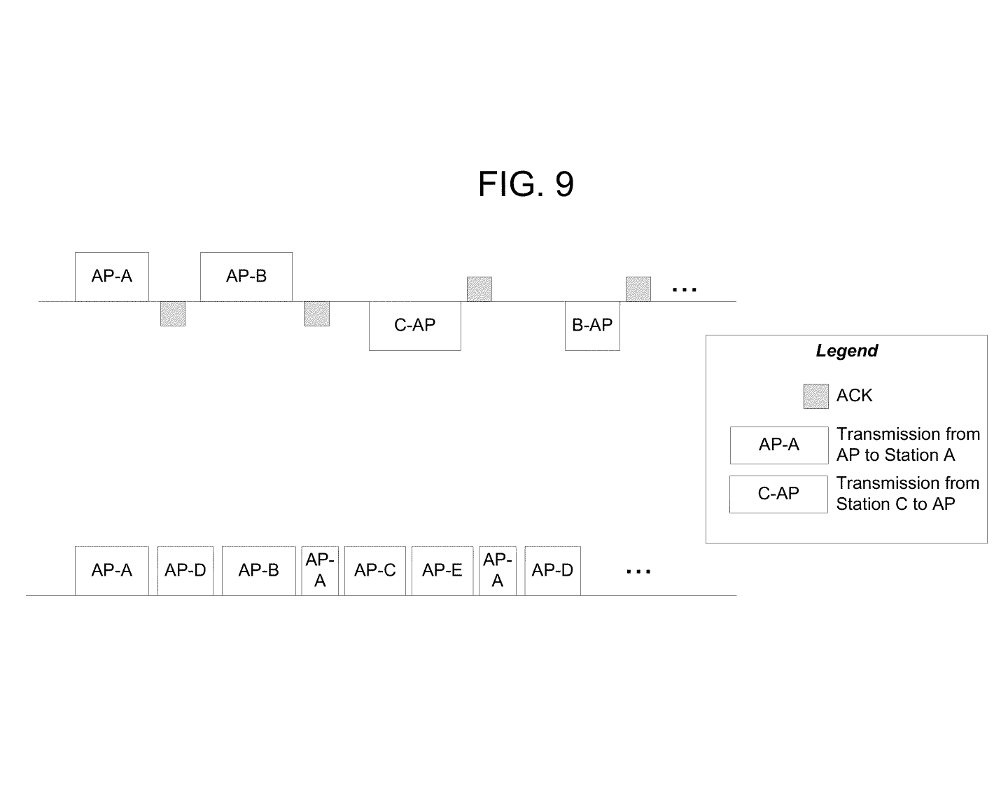

FIG. 9 is a diagram illustrating an exemplary transmission operation on an anchor channel and a supplementary channel.

Referring to FIG. 9, transmission operations on the anchor channel may include acknowledgment messages while transmission operations on the supplementary channel may use the anchor channel for those acknowledgments. For example, the anchor channel may have, in a first timing sequence, a first anchor transmission of data/control information from the AP to station A, a second anchor transmission of an acknowledgment message from station A to the AP, the third anchor transmission of data/control information from the AP to station B, a fourth anchor transmission of an acknowledgment message from station B to the AP, a fifth anchor transmission of data/control information from station C to the AP, a sixth anchor transmission of acknowledgment message from the AP to station C, a seventh anchor transmission of data/control information from station B to the AP, and an eighth anchor transmission of an acknowledgment message from the AP to station B. Each acknowledgment message may indicate whether the previous message was successfully received, for example. Since the supplementary channel may be allocated as a downlink only channel, any acknowledgment of transmissions over the supplementary channel may occur using the anchor channel.

A second timing sequence that may occur on the supplementary channel at the same time as (e.g., while) the first timing sequence is occurring on the anchor channel may include a first supplementary transmission (e.g., of data) from the AP to station A, a second supplementary transmission (e.g., of data) from the AP to station D, a third supplementary transmission (e.g., of data) from the AP to station B, a fourth supplementary transmission (e.g., of data) from the AP to station A, a fifth transmission (e.g., of data) from the AP to station C, a sixth supplementary transmission (e.g., of data) from the AP to station E, a seventh supplementary transmission (e.g., of data) from the AP to station A, and an eighth supplementary transmission (e.g., of data) from the AP to station D.

The supplementary channel may be used as added capacity that may be managed (e.g., substantially managed and/or maintained) by operations on the anchor channel. If operation in anchor channel and supplementary channels are sufficiently far apart in the frequency domain (e.g., as may be the case if the channels are in different bands), among other contemplated conditions, the operation on the supplementary channel may not have a duplex restriction (e.g., the same duplex restrictions as the anchor channels). A STA may receive or transmit (or in some embodiments perhaps only receive or transmit) at any given time on a particular channel or closely spaced adjacent channels. It is contemplated that while the STA (or AP) may be transmitting on the supplementary channel, it may be receiving on the anchor channel (or vice versa). The supplementary channel may not be restricted to be half-duplex. If the supplementary channel may be used as added capacity, the channel may be used solely for: (1) AP-to-STA (e.g., downlink (DL)) transmissions; (2) STA-to-AP (e.g., uplink (UL)) transmissions, and/or may be shared for both uplink and downlink transmissions (i.e. shared UL/DL transmissions) as described in detail below.

In the DL only transmission mode (DLOTM), the supplementary channel may be used for DL (e.g., entirely for DL) operations. For example, when the AP becomes congested with DL traffic (for instance, because of heavy load on the anchor channel or interference on the anchor carrier), among other contemplated conditions, the DLOTM mode may be used. The supplementary channel may be activated and may be used (or perhaps in some embodiments may only be used) to transport AP-to-STA traffic. As the transmissions may be controlled by the AP, the DL traffic may be scheduled by the anchor carrier (or in some embodiments perhaps entirely by the anchor carrier), and the DL traffic may be transmitted without the RTS/CTS mechanism and without CSMA. When operating in the DLOTM, the STAs may turn off their transmit circuitry for the supplementary channels.

In one or more embodiments, the DL traffic on the supplementary channel may be reserved for frames not using acknowledgments, or for broadcast/multicast frames. The traffic may be packed (or in some embodiments perhaps tightly packed) on the supplementary carrier, with an insignificant amount or no amount of interframe spacing.

In one or more embodiments, the supplementary channel may be used to carry data frames (one, some, or all of the data frames) including, for example, those that are to be acknowledged. If a data frame is to be acknowledged, among other contemplated conditions, the AP may space the DL frames to allow reception of an acknowledgement frame from the destination STA (e.g., allowing the destination STA) to: (1) process the DL frame, (2) generate an acknowledgement frame and/or (3) transmit the acknowledgement frame (e.g., with or without a delay caused by interframe spacing).

The AP may use or continue to use the anchor channel in half-duplex mode. The AP may schedule the DL traffic on the supplementary channels. If the STA is configured to monitor a DL-only supplementary channel (for instance based on the TIM IE carried in the supplementary channel operating details, parameters or information), among other contemplated conditions, the STA may monitor (e.g., continuously monitor) the supplementary channel for scheduled data. If a frame is received with the correct destination address, the frame may be recovered and may be forwarded to higher layers of the STA protocol stack for further processing.

If the STA is in a Power Save (PS) mode, among other contemplated conditions, the AP may be aware of the PS mode and may not schedule DL traffic to the STA during the times associated with the PS mode. In one or more embodiments, the supplementary channel may be used (or perhaps in some embodiments only used) for frames not having to be acknowledged (e.g., multicast and/or broadcast traffic, among others). The AP may use a fair scheduling algorithm to share the supplementary channel across STAs, and may send the traffic with an insignificant or no interframe spacing. In one or more embodiments, the supplementary channel may be used to carry data traffic (e.g., some or all data traffic including those that are to be acknowledged).

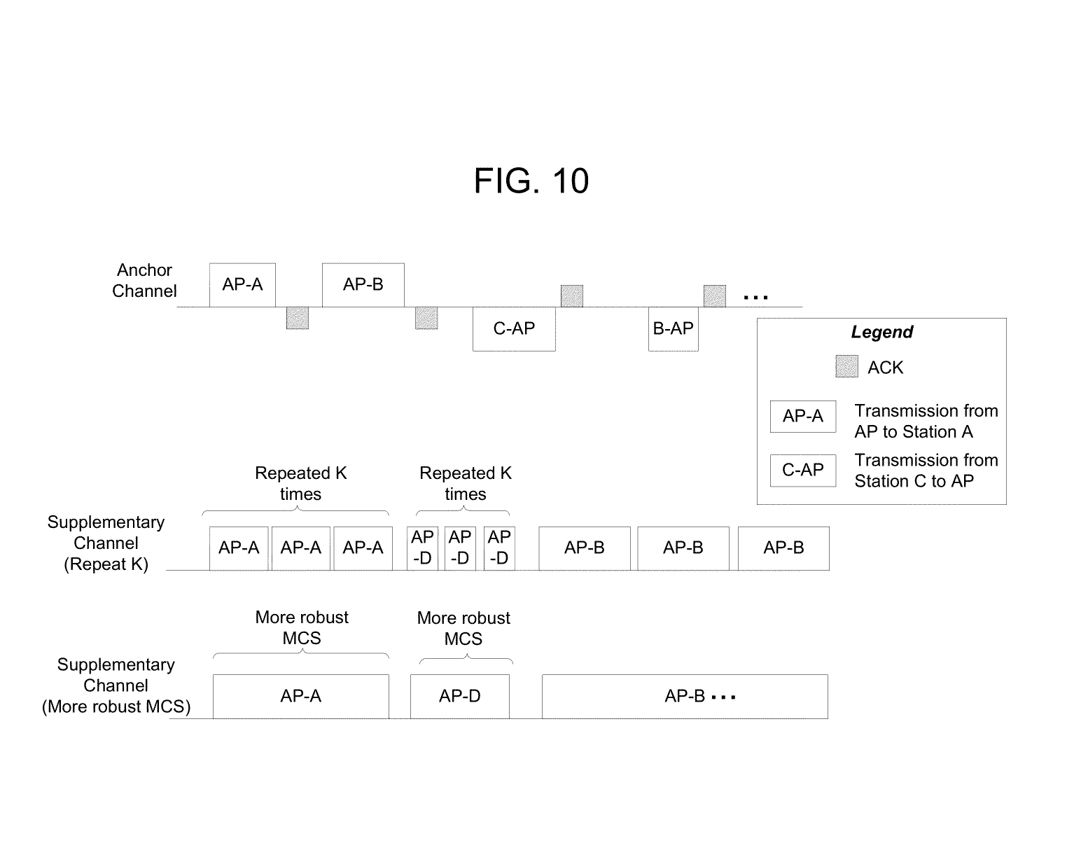

FIG. 10 is a diagram illustrating another example transmission operation on the anchor channel and supplementary channel.

Referring to FIG. 10, the timing sequence in FIG. 10 is the same as that of FIG. 9 except for the transmission operation on the supplementary channel. For frames on the supplementary channel that are to be acknowledged, the AP may use one or a combination of the following to substantially reduce or eliminate such acknowledgements:
(1) the AP may repeat a frame transmission K times in order to increase reliability and the AP may no longer expect the ACK from the STAs;
   (The number of repetitions may be configured through the supplementary channel operating details (for instance carried in the anchor channel beacon); and/or
(2) The AP may use a more robust modulation and coding scheme (MCS)
   (e.g., by using QPSK instead of 64—QAM64, for example or BPSK instead of QPSK or 64-QAM and/or a lower coding rate. The AP may no longer expect the ACK from the STAs. One of skill understands such a selection of a more robust modulation or coding scheme. In one or more embodiments, the AP may segment frames and/or may limit (or restrict) the maximum transmission times over the supplementary channel.

In a first example, in a first set of K supplementary transmissions, the AP may repeatedly send data and/or control information to station A, in a second set of K supplementary transmissions, the AP may repeatedly send data and/or control information to station D, and in a third set of K supplementary transmissions, the AP may repeatedly send data and/or control information to station B. The reliability of the transmission to each station may be increased by the repeated transmission K times. In a second example, the robustness of the MCS for each supplementary transmission on the supplementary channel may be increased.

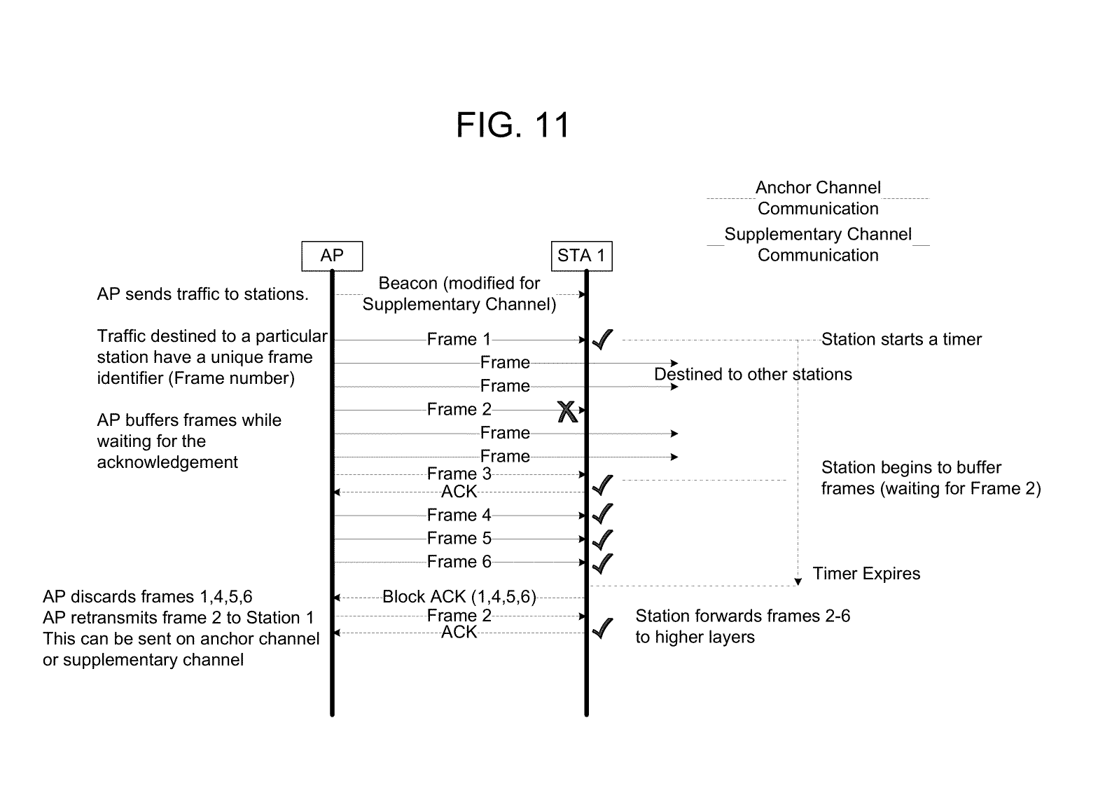

FIG. 11 is a diagram illustrating an exemplary acknowledgment procedure. In FIGS. 11-15, successful reception is indicated by a check mark while unsuccessful reception is indicated by an X.

Referring to FIG. 11, the AP may send (e.g., broadcast) to one or more stations (e.g., STA 1). The traffic may include one or more beacons modified to include information for allocation/control of the supplementary channel. The traffic may be sent over the anchor channel. The AP may send on the supplementary channel further traffic destined for the STA 1 and having a unique frame identifier (e.g., frame number). The frame (e.g., frame 1) may be successfully received by STA 1. The STA 1 may start a timer (e.g., a block acknowledgment timer).

One or more other frames may be sent on the supplementary channel by the AP and may be destined for other stations. The AP may buffer frames while waiting for an acknowledgment from the STA 1. The AP may send on the primary and/or supplementary channel more traffic destined for the STA 1 (e.g., frame 2). Frame 2, however may not be successfully received by STA 1. The AP may send on the supplementary channel additional traffic destined for the STA 1 (e.g., frame 3). STA 1, based on receiving frame 3 prior to successful reception of frame 2, may begin to buffer incoming frames while waiting for frame 2. In some embodiments, if frame 3 is sent on the primary channel, among other contemplated conditions, the STA 1 may send an acknowledgment (ACK) to the AP indicating successful reception of frame 3. The AP may send on the supplementary channel more traffic (e.g., frames 4, 5 and 6). Frames 4, 5, and 6 may be successfully received by STA 1. After successful reception of frames 4, 5 and 6, the block acknowledgment timer may expire. Responsive to the expiration of the block acknowledgment timer, the STA 1 may send over the anchor channel a block acknowledgment indicating successful reception of frames 1, 4, 5 and 6. Responsive to receipt of the block acknowledgment, the AP may discard or erase frames 1, 4, 5 and 6 and may retransmit frame 2 to the STA 1. The retransmission of frame 2 may be sent on the anchor channel to increase reliability or resent over the supplementary channel. The STA 1 may then forward the frames (e.g., frames 2-6) to higher layers in the STA 1's protocol stack.

For example, the STA may use a first type of acknowledgement mechanism to transmit the acknowledgement to the AP. In one representative ACK procedure (e.g., ACK procedure 1), the STA may send a block acknowledgement for the frames (e.g. some or all frames) received on the supplementary channel. A block ACK may be sent by STAs (e.g., some or all STAs) having received frames on the supplementary channel. The block ACK message may be sent on the anchor channel. The block ACK message may have a higher priority associated with it to reduce latency (e.g., overall latency). The transmission of the block ACK may be tied to or may correspond with the timing of the TBTT. For example, the transmission of the block ACK (e.g., associated with data received after a beacon is received) may be sent before the next TBTT. As a second example, the block ACK transmission may be triggered based on a maximum configured ACK latency is exceeded (e.g., using a timer). For example, the STA may send a block ACK, if the time since reception of the oldest un-ACKed frame exceeds a threshold. In order for the AP to cross-reference the frame being ACKed, the AP may use a frame identifier that may be included in the frames (e.g., some or all frames) sent over the supplementary channel. The frame identifier may be unique for each STA or may be global across STAs (e.g., some or all STAs). In one or more embodiments, the AP may use the STA identity (AID) and the frame identifier to uniquely identify the frame being acknowledged.

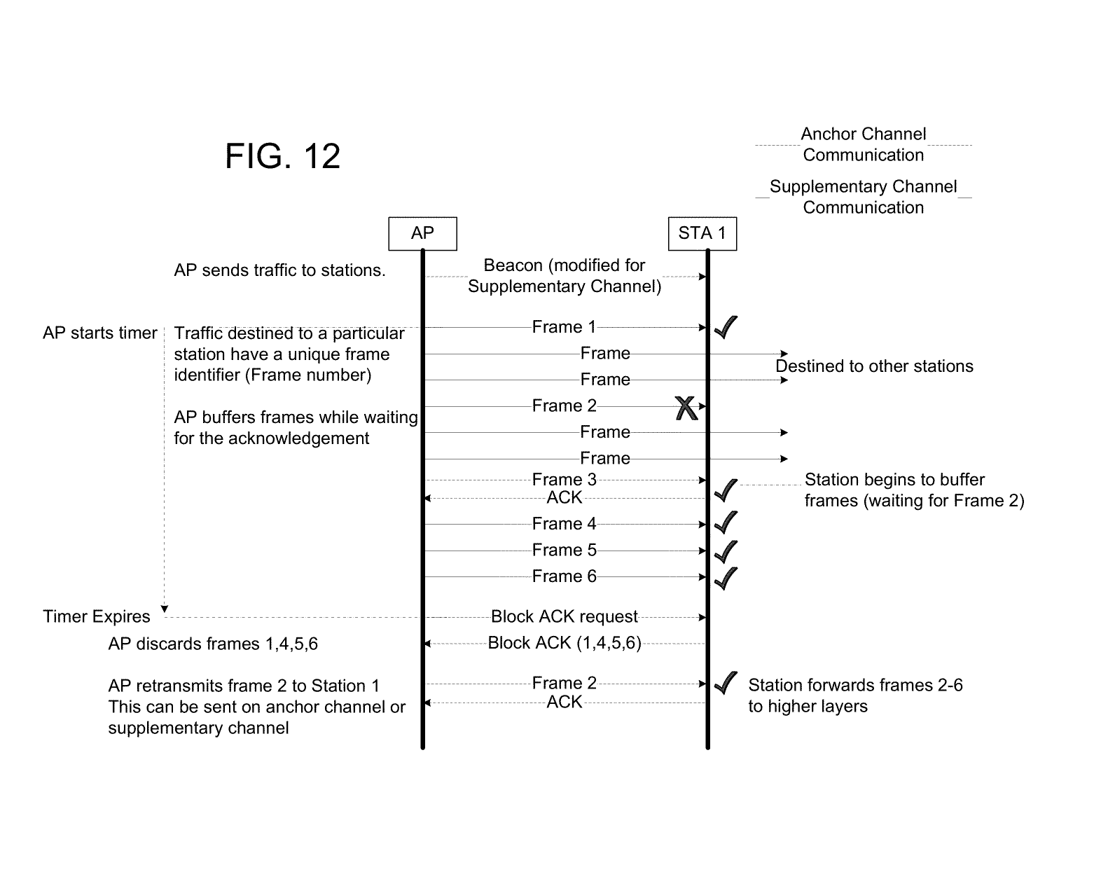

FIG. 12 is a diagram illustrating another exemplary acknowledgment procedure.

Referring to FIG. 12, the AP may send (e.g., broadcast) to one or more stations (e.g., STA 1). The traffic may include one or more beacons modified to include information for allocation/control of the supplementary channel. The traffic may be sent over the anchor channel. The AP may send on the supplementary channel further traffic destined for the STA 1 and having a unique frame identifier (e.g., frame number). The frame (e.g., frame 1) may be successfully received by STA 1. The AP may start a timer (e.g., a block acknowledgment timer).

One or more other frames may be sent on the supplementary channel by the AP and destined for other stations. The AP may buffer frames while waiting for an acknowledgment from the STA 1. The AP may send on the supplementary channel and/or the primary channel more traffic destined for the STA 1 (e.g., frame 2). Frame 2, however, may not be successfully received by STA 1. The AP may send on the supplementary channel additional traffic destined for the STA 1 (e.g., frame 3). STA 1, based on receiving frame 3 prior to successful reception of frame 2, may begin to buffer incoming frames while waiting for frame 2. In some embodiments, if frame 3 is sent on the primary channel, among other contemplated conditions, the STA 1 may send an acknowledgment (ACK) to the AP indicating successful reception of frame 3. The AP may send on the supplementary channel more traffic (e.g., frames 4, 5 and 6). Frames 4, 5, and 6 may be successfully received by STA 1. After successful reception of frames 4, 5 and 6, the block acknowledgment timer may expire. Responsive to the expiration of the block acknowledgment timer, the AP may send a block acknowledgement request over the anchor channel to the STA 1 and the STA 1 may send over the anchor channel a block acknowledgment indicating successful reception of frames 1, 4, 5, and 6. Responsive to receipt of the block acknowledgment, the AP may discard or erase frames 1, 4, 5 and 6 and may retransmit frame 2 to the STA 1. The retransmission of frame 2 may be sent on the anchor channel to increase reliability or resent over the supplementary channel. The STA 1 may then forward the frames (e.g., frames 2-6) to higher layers in the STA 1's protocol stack.

For example, the STA may use a second type of acknowledgement mechanism to transmit an acknowledgment to the AP. In a second representative ACK procedure (e.g., ACK procedure 2), the STAs may be queried (or polled) on the anchor carrier. The query message may be set with a high priority (e.g., higher than, for example, other data messages). The AP may send a broadcast ACK query probe. The STAs, responsive to receipt of the broadcast ACK query probe, as a trigger, may commence Block ACK transmissions. In one or more embodiments, the AP (e.g., which may know the STAs using or sent traffic on the supplementary channel) may query those STAs individually. The AP may send a query message based on the time since the last unacknowledged frame. For example, a query message may be sent if the time since the last unacknowledged frame exceeds a threshold. A timer may be started for the first unacknowledged frame. At expiration of the timer, among other conditions, the AP may query the STA to send a block ACK. As a second example, the query message may be sent based on a number of frames or unacknowledged frames sent to each STA such that the query message may be sent after the transmission of K frames or K unacknowledged frames over the supplementary channel.

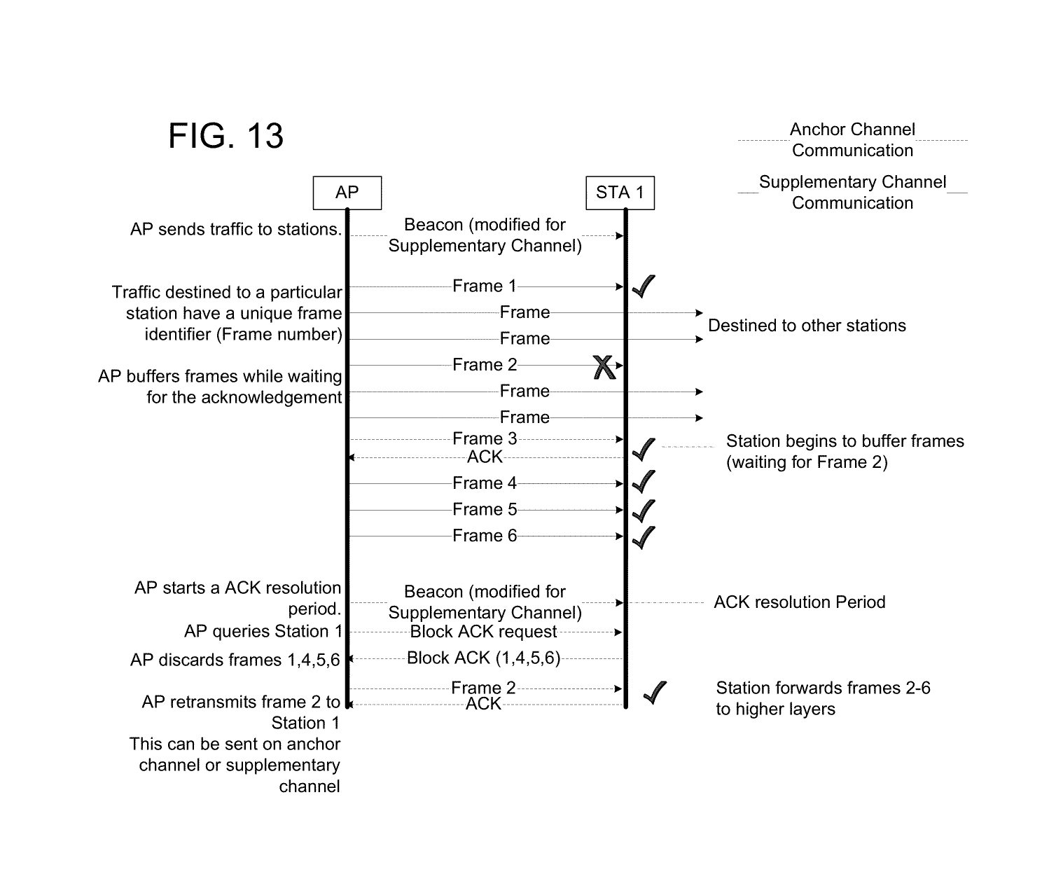

FIG. 13 is a diagram illustrating another example acknowledgment procedure.

Referring to FIG. 13, the AP may send (e.g., broadcast) to one or more stations (e.g., STA 1). The traffic may include one or more beacons modified to include information for allocation/control of the supplementary channel. The traffic may be sent over the anchor channel. The AP may send on the supplementary channel further traffic destined for the STA 1 and having a unique frame identifier (e.g., frame number). The frame (e.g., frame 1) may be successfully received by STA 1.

One or more other frames may be sent on the supplementary channel by the AP and destined for other stations. The AP may buffer frames while waiting for an acknowledgment from the STA 1. The AP may send on the supplementary channel and/or the primary channel more traffic destined for the STA 1 (e.g., frame 2). Frame 2, however may not be successfully received by STA 1. The AP may send on the supplementary channel additional traffic destined for the STA 1 (e.g., frame 3). STA 1, based on receiving frame 3 prior to successful reception of frame 2, may begin to buffer incoming frames while waiting for frame 2. In some embodiments, if frame 3 is sent on the primary channel, among other contemplated conditions, the STA 1 may send an acknowledgment (ACK) to the AP indicating successful reception of frame 3. The AP may send on the supplementary channel more traffic (e.g., frames 4, 5 and 6). Frames 4, 5, and 6 may be successfully received by STA 1. The AP may send one or more additional beacons over the anchor channel modified to include the information for allocation/control of the supplementary channel. After sending the beacons, the AP may start an Acknowledgement resolution period and may send a block acknowledgement request over the anchor channel to the STA 1. The STA 1 may send over the anchor channel a block acknowledgment indicating successful reception of frames 1, 4, 5 and 6. Responsive to receipt of the block acknowledgment, the AP may discard or erase frames 1, 4, 5 and 6 and may retransmit frame 2 to the STA 1. The retransmission of frame 2 may be sent on the anchor channel to increase reliability or resent over the supplementary channel. The STA 1 may then forward the frames (e.g., frames 2-6) to higher layers in the STA 1's protocol stack.

For example, the STA may use a third type of acknowledgement mechanism to transmit an acknowledgment to the AP. In a third representative ACK procedure (e.g., ACK procedure 3), the AP may establish or define an ACK resolution period, for instance after (e.g., immediately after) the beacon. During the ACK resolution period, the AP may query the individual STAs for which it expects an acknowledgement.

Each of the ACK procedures (e.g., ACK procedures 1, 2 and/or 3) may be enhanced such that the STAs may be configured to opportunistically piggyback the ACK information in ongoing communications in the anchor channel (e.g., in the frame header of the STA to AP transmissions).

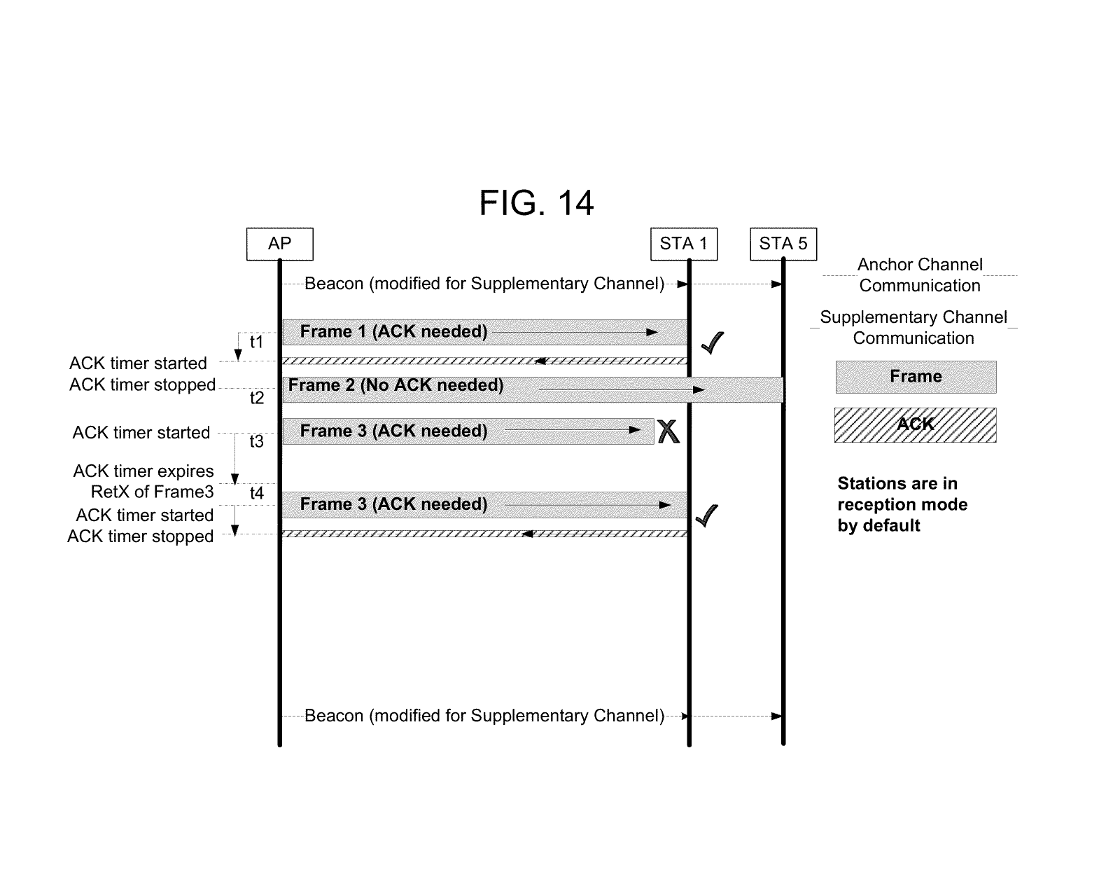

FIG. 14 is a diagram illustrating another exemplary acknowledgement procedure.

Referring to FIG. 14, the AP may send (e.g., broadcast) beacons over the anchor channel to one or more stations (e.g., STA 1 and STA 5). The beacons in the traffic may be modified for allocation/control information for allocating and/or controlling the supplementary channel. At time t1, a frame (e.g., frame 1) may be sent over the supplementary channel from the AP destined for STA 1 and may start an acknowledgment timer. Frame 1 is to have an acknowledgment. Responsive to successful reception of frame 1 by STA 1, STA 1 may send an acknowledgment message to the AP. Since the acknowledgment message is received prior to the acknowledgment timer expiring (e.g., prior to the response time exceeding a threshold time), the acknowledgment timer may be stopped and the AP may consider or determine that frame 1 successfully reached STA 1. At time t2, a second frame (e.g., frame 2) may be sent over the supplementary channel from the AP destined for STA 5. Frame 2 may not have an acknowledgment and an acknowledgment timer may not be started. At time t3, a frame (e.g., frame 3) may be sent over the supplementary channel from the AP destined for STA 1 and may start an acknowledgment timer. Frame 3 is to have an acknowledgment. Since frame 3 is not successfully received by STA 1, STA 1 may not send an acknowledgment message to the AP. Since the acknowledgment message is not received prior to the acknowledgment timer expiring (e.g., prior to the response time exceeding a threshold time, for example T4-T3 exceeding a threshold), the AP may retransmit or resend frame 3. The retransmitted or resent frame 3 may use the same procedure as frame 1, may be successfully received by STA 1 and may be acknowledged before the acknowledgment timer expires.

In one or more embodiments, the AP may schedule complete transactions between itself and the stations. Both the DL transmission and any potential UL acknowledgment frame associated with each DL transmission may be scheduled by the AP. As a result, the supplementary channel may have DL frames interspersed with UL ACKs from the stations. In this mode, the AP may not contend for the medium (e.g., no CSMA procedure may be undertaken) prior to initiating a DL transmission. It is contemplated that the APs and the stations may toggle between the reception mode (e.g., in which the AP may receive acknowledgements and stations may receive frames) and the transmission mode (e.g., in which the AP may send frames and stations may send acknowledgements). The AP schedules DL frames, and for those to be acknowledged, the AP may start a timer waiting for the station ACK. If the timer expires before reception of the ACK, the AP determines (by inference) a failed transmission and may perform a frame retransmission.

In one or more embodiments, the AP may use the supplementary channel to send Frame 1 to station 1. For example, as Frame 1 is to have acknowledgement, the AP may start an ACK timer at time t1 (e.g., the end of Frame 1). The AP then may transition to reception mode for the supplementary channel, in order to receive the acknowledgement for Frame 1. During this time, the AP may not send any new frames on the supplementary, although it may begin to prepare and schedule a future frame. If an acknowledgement is received, the AP may stop the timer, may switch to transmission mode, and may send the new scheduled frame (Frame 2). In this case, Frame 2 (which is destined to station 5) may not use acknowledgement. As a result, at the end of the transmission (time t2) the AP may schedule and may transmit another frame (Frame 3). This frame (destined to Station 1) may use an acknowledgement. At the end of transmission, the AP may switch mode (to reception mode) and may restart the ACK timer (at t3). If the ACK is not received before the expiry of the timer (at t4), the AP may know that the frame was not received. It may change to transmission mode and resends Frame 3. This frame may be successfully received at the station.

From a STA perspective, the STAs (e.g., some or all of the STAs) may be in reception mode for the supplementary channel and may be controlled or dynamically changed each beacon interval by information carried in the beacon. For instance, a STA may know that it is not to be scheduled in the upcoming beacon interval and may shut down its supplementary channel operation. For those STAs that may be scheduled in a beacon interval, the STAs may be by default in reception mode. During this mode, if the STAs correctly receive a frame that is to be acknowledged (e.g. Frame 1 in FIG. 14), they may generate the ACK frame, may transition to transmission mode, and after an appropriate inter-frame spacing, may send the ACK to the AP. This interframe spacing may be the SIFS or a newly defined inter-frame spacing. After transmission of the ACK frame, the stations may return to reception mode.

In one or more embodiments, an uplink (UL) Only Transmission Mode (ULOTM) may be used for the supplementary channel operations, for example, where the system bottleneck may be the UL. The supplementary channel may be activated and may be used (e.g., only used) to transport STA-to-AP traffic. When operating in the ULOTM mode, the STAs may turn off, power-off or power down their receive circuitry for the supplementary channels.

In one or more embodiments, the supplementary channel may use a fixed reservation-based access scheme, where the supplementary channel may be shared (between or among STAs) in a round robin (e.g., fixed round-robin) manner. A first STA (e.g., STA 1) may be given ownership or control of the supplementary channel for a certain fixed period (e.g., from time t0 to t1). A second STA (e.g., STA 2) may be given ownership or control of the supplementary channel for another fixed period (e.g., from time t1 to t2). Other STAs may be given control for other respective periods. The ownership or control time may be tied to beacon intervals. For instance, STA K may have ownership or control (e.g., for transmission of data in the UL) of the supplementary channel for a certain time duration (T_K) each beacon interval or every L beacon intervals. The fixed pattern may be included or indicated in a RSM that may be controlled by the AP and may be signaled to the STAs. The signaling may be carried in the anchor channel beacon, or it may be signaled on the supplementary channel. The AP may modify the schedule of the STAs associated with the AP, when a new STA associates to the AP, or when a currently associated STA disassociates from the AP. Depending on the synchronization, among other conditions, the AP may determine whether to configure a guard time between transmissions from different associated STAs.

In one or more embodiments, the supplementary channel may use a demand reservation-based access scheme, and may use the anchor channel as its reservation channel. Respective STAs may send reservation requests (including, for example, their buffer state, and/or queue size, among others) to the AP on the anchor carrier, for instance, using a new MAC frame or by piggybacking the request on an existing data frame transmission. The AP may store the information for the STAs (e.g., some or all STAs or only the STA requesting reservations) may implement a scheduler to distribute the capacity on the supplementary channel, and may signal the assignment to the STAs. The signaling for the assignments may be: (1) carried in the anchor channel beacon; (2) carried in a new MAC frame on the anchor channel; (3) piggybacked with a DL frame in the anchor channel; and/or (4) carried in a new MAC frame on the supplementary channel, among others.

In one or more embodiments, the supplementary channel may use a contention based access scheme, and may use a CSMA type mechanism in a CSMA contention based access mode (CCBAM). Each STA may follow the rules for sensing the channel and transmit (or in some embodiments perhaps only transmit) if the channel is sensed to be free for an interframe spacing time. A new interframe spacing may be established or defined for the supplementary channel, for example, to allow for efficient sharing of the capacity. To reduce the impact of hidden nodes, the supplementary channel operating in a CCBAM may restrict the maximum frame size. The ACK feedback for the UL frames may be carried in the anchor channel. The AP may send the ACK to the UL STAs after the beacon, in an ACK resolution period. The information may be coded in a single broadcast message that may include the address of the STA being acknowledged and/or an indication of the packet that is being acknowledged (for instance, using a frame identifier).

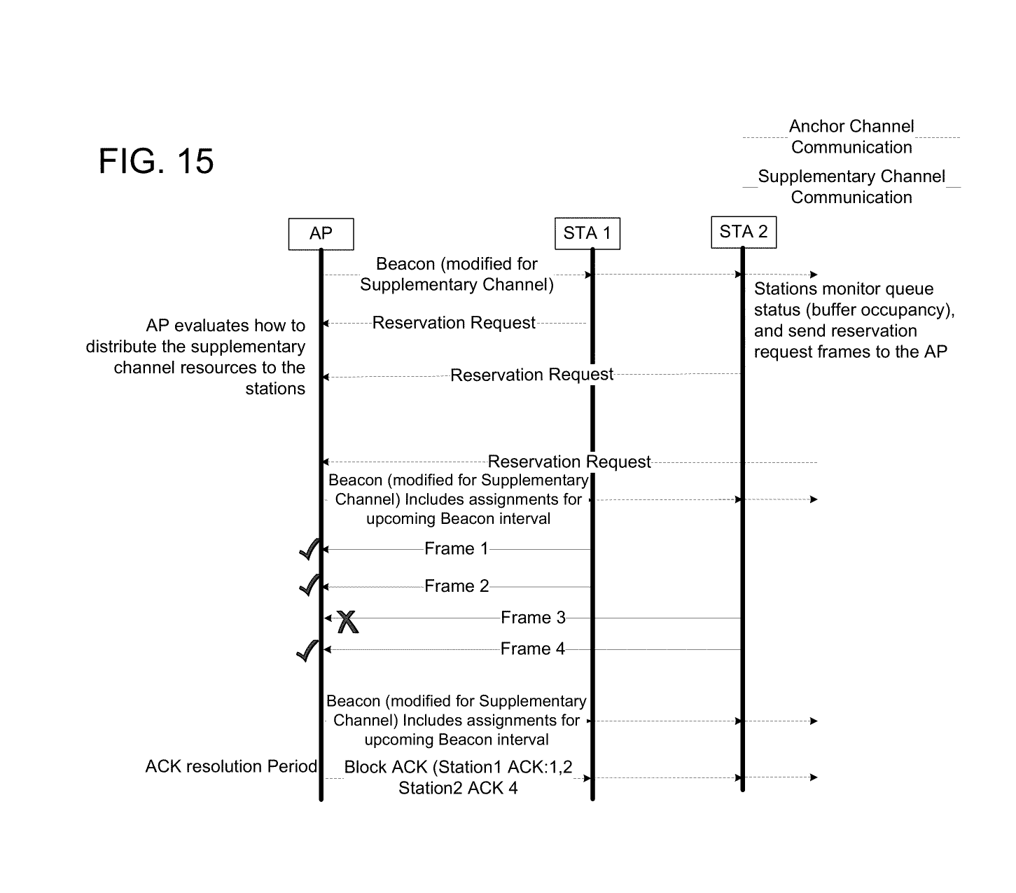

FIG. 15 is a diagram illustrating an example acknowledgement procedure for ULOTM, using the demand reservation-based access scheme, as an example. It is contemplate that modifications of this acknowledgement procedure may apply to other above-identified schemes.

Referring to FIG. 15, the AP may send on the anchor channel broadcast beacons to one or more STAs (e.g., STA 1 and STA 2 . . . STA N) served by the AP. Each STA may monitor their respective queue status (e.g., buffer occupancy or availability) and/or other parameters indicating reservation priority by the STA. Each STA 1, 2, etc. N may send a reservation request frame to the AP over the anchor channel. The reservation request frame may indicate the respective STA's queue status and/or reservation priority. The AP may receive the reservation request frames from each STA 1, 2, etc. N and may evaluate or determine distribution/allocation of supplementary channel resources for each station (e.g., STA 1, 2 . . . N) during the upcoming beacon interval.

The AP may send or broadcast on the anchor channel beacons to the STAs served by the AP. The beacons may include (e.g., may be modified to include) control/allocation information for controlling/allocating the supplementary channel (e.g., including the assignments in the upcoming beacon interval). For example, STA 1 may have an allocation/assignment to transmit its frame numbers 1 and 2 on the supplementary channel during the upcoming beacon interval and STA 2 may have an allocation/assignment to transmit its frame numbers 3 and 4 on the supplementary channel during the upcoming beacon interval. STA 1 and 2 may send traffic on the supplementary channel at their assigned or allocated time slots. For example, responsive to the traffic sent from STA 1 being successfully received and frame 4 sent from STA 2 being successfully received, but frame 3 sent from STA 2 not being successfully received after the next beacon interval begins, an acknowledgment resolution period is initiated by the AP. The AP may first broadcast on the anchor channel the beacons with the assignment information for the upcoming beacon interval and then may send (e.g., broadcast) on the anchor channel a block acknowledgment including acknowledgment of the successful receipt of frame 1 and 2 sent from STA 1 and acknowledgment of successful receipt of frame 4 sent from STA 2.

In one or more embodiments, the supplementary channel may use a Bi-Directional transmission Mode (BiDTM) for both UL and DL operations (e.g., where intra-LAN traffic may be higher than a threshold amount). For example, the traffic may be mostly between STAs in the network managed by the AP and may cause heavy traffic in both the UL and DL.

In one or more embodiments, the supplementary channel may be tied to the anchor channel transmissions. The STAs (e.g. some or each STA) and the AP may use primary channel sensing, and may use the anchor channel as the primary channel. If the AP or a particular STA wins the contention on the anchor channel (e.g., controls the transmission on the anchor channel), it may transmit on both the anchor and supplementary channel. The AP and STAs may rely on or use predetermined or dynamically established aggregation rules.

In one or more embodiments, the AP and/or STAs may obtain access to the supplementary channel or channels independently from access to the anchor channel. The AP and/or STA may use aggregation rules that may allow 2 or more independent TXOPs across the anchor channel and the supplementary channels. For example, a STA that desires to send some MAC packets to the AP may perform CSMA procedure concurrently on both the anchor channel and the primary channel of the supplementary channels and may send the MAC packets on the channels it has win access to first. A STA may not have the capability to perform concurrent CSMA operation and may autonomously or by the AP configure itself to perform CSMA access on the supplementary channel or channels (or in some embodiments perhaps only the supplementary channels) or on the anchor channel (or perhaps in some embodiments perhaps only the anchor channel) for a given period (e.g., the configuration or reconfiguration may be dynamic and based on measurements, traffic monitoring, and/or a congestion threshold, among others. The AP may select and may send information to the STAs about the CSMA access procedure it is allowed to use including which channel is the primary channel for a set of supplementary channels. The information may be sent over a management frame or beacon on the anchor channel.

The anchor channel may include information for the scheduled TXOPs for the supplementary channels. The signaling may be carried: (1) in the anchor channel beacon, or (2) in a new MAC management message on the anchor channel.

In one or more embodiments, the supplementary channel may use a spatial reuse mode (SReM) in which either DL or UL direction may be allocated independently by individual STA using beamforming techniques (e.g., which may be useful when the supplementary channel may be in a higher frequency band (exceeding a threshold frequency) or in a frequency band above the anchor channel frequency).

The same supplementary channel can be used simultaneously over multiple AP-STA links using beamforming on each link to mitigate interference in the spatial domain. For example, each link may be operated independently in the UL or DL direction (e.g., a particular supplementary channel may be operated in DL mode for a link between the AP and STA1 while the supplementary channel may be operated in UL mode between the AP and STA2).

In one or more embodiments, on each AP-STA link, multiple supplementary carriers may be supported such that a first portion of the supplementary carriers may be in DL beamforming mode while a second portion of the supplementary carriers may be in UL beamforming mode.

In one or more embodiments, multiple supplementary channels may use a variable duplex spacing mode (VDSM) such that the multiple supplementary channels may be spaced arbitrarily apart in frequency from each other and the individual channels may be assigned to operate in the either of the DLTOM or ULTOM. Any self-interference due to leakage of signals from one the transmit chains into the receive chains may be minimized using either one or both of the following:
(1) self-interference cancellation at the radio front end so that the leaked signals from the transmit chain into the receive chain may be cancelled using adaptive filtering (e.g., Normalized Least Mean Squares (NLMS) and/or Recursive Least Squares (RLS) equalizers, among others; and/or
(2) tuneable filters (e.g., either in analog or digital domain) with high out-of-band rejection may be used to effectively filter signals leaked from adjacent bands.

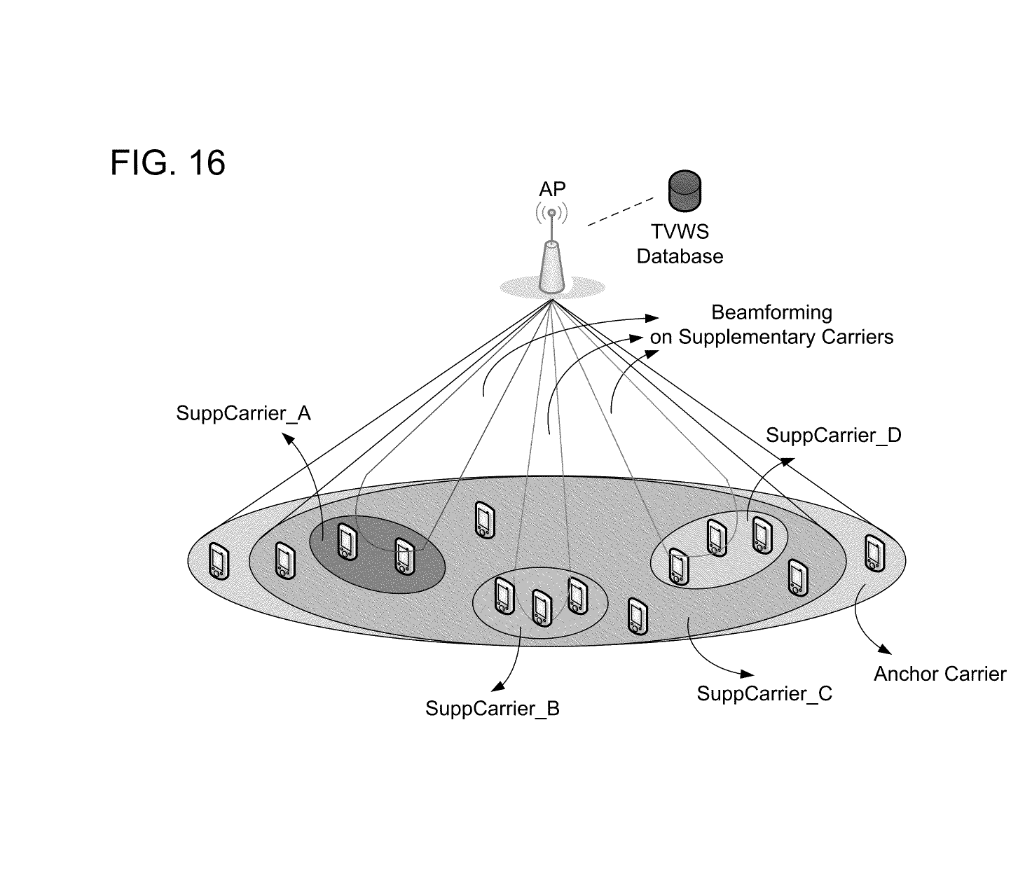

FIG. 16 is a diagram illustrating an exemplary AP coverage area using a plurality of supplementary channels/carriers.

Referring to FIG. 16, the AP may be in communication with a TVWS database to inform the AP of available TVWS supplementary channels. Based on the TVWS information from the TVWS database or measurements from the STAs, supplementary carriers/channels A, B, C and D may be available in the APs coverage area (e.g., the entire coverage area). Supplementary carriers/channels A, B and D may use beamforming to provide coverage in non-overlapping portions of the APs anchor carrier coverage area. Supplementary carrier/channel C may use beamforming to provide coverage that overlaps supplementary carriers/channels A, B and D. The anchor carrier/channel may cover the AP's entire coverage area. Beamforming by the AP on the supplementary carriers/channels may enable joint coverage of the STAs while enhancing capacity between the AP and the STAs. For example, certain STAs may be allocated channels on more than one supplementary carrier (e.g., in overlapping supplementary carrier/channel areas).

In one or more embodiments, the TVWS band may be used to carry the anchor channel. Lower frequency bands may be better suited to support large coverage areas by the AP. The higher frequency bands may be better suited for providing high throughput in close proximity to the AP because larger swaths of spectrum are available for use and/or because of the ease of achieving high spatial beamforming gains using antenna arrays. In one example, joint coverage and capacity enhancements may be enabled via inter band carrier aggregation using the lower frequency band, as the anchor carrier, to enable robust connectivity with the AP across a large coverage area while the high frequency bands are aggregated with the anchor carrier, as a supplementary carrier, to provide capacity enhancements. It is contemplated that the anchor carrier may implement the CSMA approach for channel access by the STAs and the supplementary carrier may be used in DLTOM, ULTOM and/or BiDTM.

It is contemplated that the AP may dynamically switch between or among the operating modes, for example, based on: (1) buffer conditions or states of the AP or STAs, (2) capacity of the links; (3) congestion measurements of the links; and/or (3) estimated throughput for the links, among others.

In one or more embodiments, a tuneable filter (e.g., analog or digital) may be used on the supplementary band. For example, one or more tuneable filters may be used in the radio front-end for the supplementary bands (e.g., the higher frequency bands) to dynamically adjust the bandwidth and carrier frequency based on capacity requirements. The tunable filters may also maintain the in-band noise to a minimum.

In one or more embodiments, spatial multiplexing may be used on the supplementary band. For example, the anchor carrier may use traditional CSMA, (e.g., in the TVWS band), and the supplementary carrier may be allocated to users (e.g., and may use beamforming). The supplementary carrier may provide capacity enhancements while the primary carrier may provide a large coverage area, for example, to enable efficient spatial reuse of the supplementary channels while providing significant capacity gains to the STAs. The STAs closer to the AP (e.g., with a location determined to be within a threshold distance or a signal level above a threshold amount) may use the anchor carrier (or in some embodiments perhaps exclusively) for control plane signaling while the supplementary channel or channels may be used for data plane communication. The remaining STAs (e.g., not meeting such a criteria and/or further away from the AP) may use the physical resources on the anchor carrier for data and control plane signaling.

In one or more embodiments, the system (e.g., the AP and/or STA) may initiate a swap of the anchor channel and the supplementary channel, such that the current anchor channel may become the new supplementary channel and the current supplementary channel may become the new anchor channel. The swap, for example, may be based on the supplementary channel quality exceeding that of the anchor channel, or when the anchor channel becomes unavailable. In such cases, the system may choose the best available supplementary channel as the new anchor channel. The new anchor channel may be, for example, in the TVWS or in the ISM bands. The system may determine when the existing anchor channel becomes unavailable, e.g., by using the beacons. For example, if a certain number of consecutive beacons or the ratio of lost beacons to overall beacon in a period of time exceeds a threshold ratio (e.g., 5 beacons may be lost or 50% of the beacons may be lost), the STA may know or determine that the anchor channel is to be changed. Since different STAs may undergo different interference, and their observation of the beacon receptions may be different, the AP may receive different STAs report of different quality for the anchor channel. It is contemplated that there may be no alternative channel which is perceived to or is better for all or a majority of the STAs served by the AP. In at least one example embodiment, if the beacon loss threshold is 5 and the actual beacon losses are as follows in Table 1:

TABLE 1

| | Current anchor channel | Alternative channel |
|---|---|---|
| STA 1 | 6 beacon losses | 4 beacon losses |
| STA 2 | 7 beacon losses | 8 beacon losses |
| STA 3 | 3 beacon losses | 1 beacon loss |

The AP may count the number of STAs whose beacon losses are greater than the threshold for each channel, may select the channel with the minimum count as the new anchor channel, and may disseminate the information on the new anchor channel (e.g., if there is a change to the anchor channel) to the STAs (e.g., some or all of the STAs served by the AP).

For example, in this representative example, two STAs have beacon losses greater than the threshold (e.g., STA1 and STA2) for the current anchor channel, while one STA (e.g., STA2) has a beacon loss greater than the threshold for the alternative channel. And the AP may switch the anchor to the alternative channel.

Other mechanisms may be used for selection of the anchor channel including selection based on: (1) a count of the total number of lost beacons for the channels involved; and/or (2) a count of the total number of lost beacons for the channels involved with any outlier STAs excluded (e.g., the highest and/or lowest beacon loss counts from the STAs excluded).

Although the determination to swap or switch the anchor channel is disclosed to be based on beacon losses, it is contemplated that it may be based on other parameters including successful beacon receipt by the STAs. In cases where the supplementary channel is not broadcasting a beacon, the AP may use other measures or parameters to determine channel quality, for example, Bit Error Rate, retransmission frequency, Signal-to-Inference Ratio and/or Signal-to-Noise Ratio, among others.

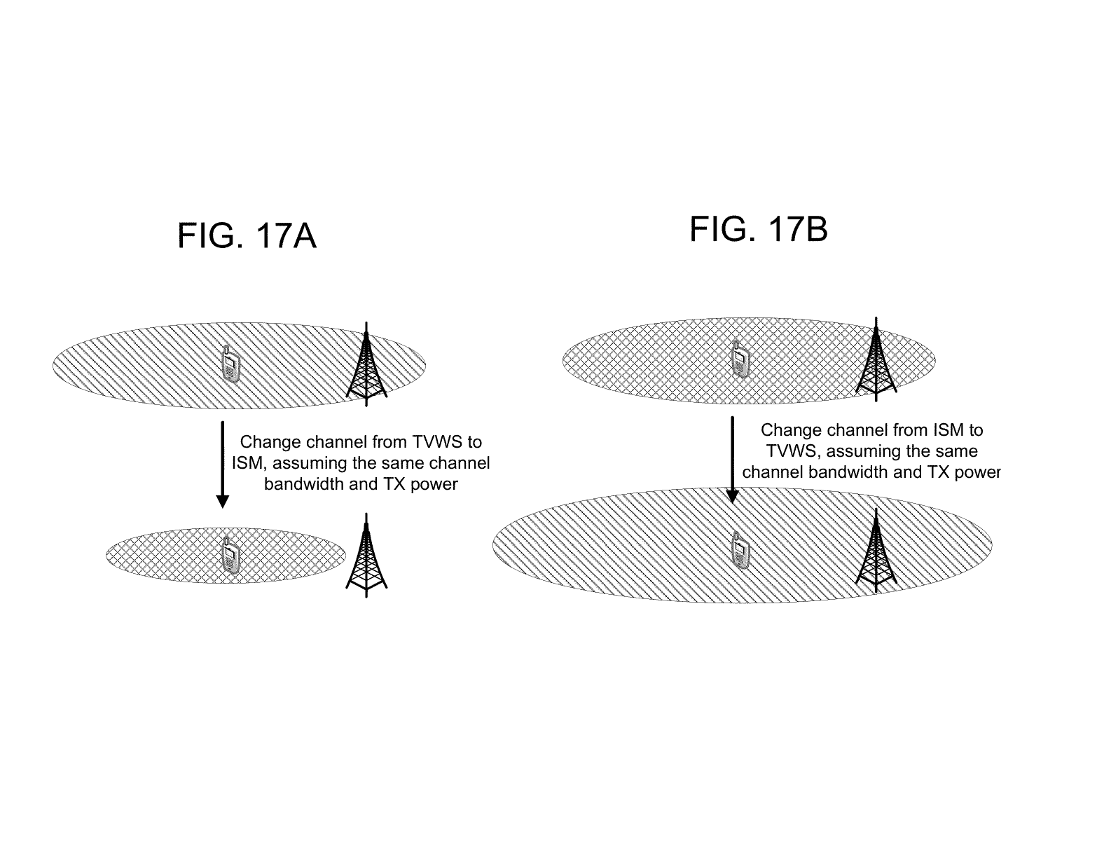

FIG. 17A is a diagram illustrating an exemplary coverage area change when changing channels from TVWS to ISM band (e.g., while keeping the same channel bandwidth and TX power) and FIG. 17B is a diagram illustrating a coverage area change when changing channels from ISM band to TVWS (e.g., while keeping the same channel bandwidth and TX power).

Referring to FIGS. 17A and 17B, a procedure (e.g., a mobility procedure) may be used for handovers between supplementary channels in different bands, for example, when radios switch channels between two bands from one band to another band, and the two bands have different carrier frequencies and/or bandwidths. With the same configuration after the switch over (e.g., the same transmission power and modulation and coding scheme (MCS)), the communication ranges may be different (e.g., very different), and the impacts of interference may be different (e.g., very different) as discussed below.

In some embodiments, the lower the carrier frequency, the larger the communication range. For example, using a free space radio propagation model, the received power may be proportional to the square of the wavelength. The carrier frequency for the TVWS is in the range between 512 MHz and 698 MHz (excluding channel 37), whereas the carrier frequency for the ISM band used by IEEE 802.11/b/g is much higher at 2.4 GHz. Under the free space radio propagation model, a radio operating in the TVWS may have a communication range approximately 4 times as great as a radio operating in the 2.4 GHz ISM band with the same configuration.

When the bandwidth changes, among other conditions, the power spectrum density may change in the opposite direction. When the transmission power is fixed, among other contemplate conditions, if the bandwidth increases, the power spectrum density may decrease, and if the bandwidth decreases, the power spectrum density may increase. A reduction of channel bandwidth with the transmission power fixed may result in a sudden increase in the out-of-band emission (OOBE), which may lead to potential violation of the interference limit imposed by spectrum access policies. As an example, if the bandwidth of a channel in the 2.4 GHz ISM band is 20 MHz, and the bandwidth of a channel in the TVWS in the U.S. is 6 MHz. when a radio switches between channels of different bandwidths, the impact of the change in bandwidth may be considered or determined to ensure service continuity. Without communication range matching, the service continuity may not be guaranteed, or inefficiency may occur. In one or more embodiments, the communication ranges for the channels or frequency bands being switched may be matched, for example, to make the capacity of the communication link remain approximately the same when the radios switch among different bands.

The capacity of the communication link may depend on a number of factors including, for example: (1) channel bandwidth; (2) SNR; (3) attenuation; (4) carrier frequency or bands; and/or (5) MCS, among others. The capacity generally refers to the raw throughput that is achievable under the constraint of available configurations of the radios. The TX power may be estimated as shown in Equation 1:

P_{RX}=α(f)P_{TX}/rⁿ (1)

where α(f) is a function of carrier frequency f, P_{TX} is the TX power, r is the distance between the transmitter and the receiver, and n≧2 is the attenuation exponent.

A representative procedure for range matching two channels Channel 1 and Channel 2, which are in Band 1 and Band 2, respectively, may include:
(1) for the change from Channel 1 to Channel 2, estimate the channel capacity of Channel 1 (e.g., using C1=B1 log₂(1+SINR1), where B1 is the bandwidth of Channel 1, SINR1 is the Signal to Interference and Noise Ratio.
(2) for each TX power level (e.g., quantized TX power which is quantized into a number of levels), a set of channels (called Channel 2) in Band 2 may be determined such that |C2−C1| is minimized where C2=B2 log₂(1+SINR2). B2 is the total bandwidth to be used in Band 2, and itself may consist of a number of channels. For example, in the TVWS, B2 may be equal to the bandwidth of multiple TV channels. The SINR2 may be affected by the choice of Channel 2, the TX power, and/or the carrier frequency; and
(3) find the minimum TX power and the MCS scheme for Channel 2 such that |T2−T1|<γ T1, where T1 is the raw throughput of Channel 1, T2 is the raw throughput of Channel 2, and γ is a constant between 0 and 1. The minimum TX power may be chosen that satisfies the above constraint to alleviate interference (e.g., unnecessary interference).

Another procedure may generate policies and create look-up tables for fast implementation based on the above algorithm or other range matching algorithms.

In one or more embodiments, a single master clock may be used to control both the anchor channel and the one or more supplementary channels.

It is contemplated in one or more embodiments that two channels of different bandwidths may be controlled using a master clock. In one representative embodiment, a first channel may be 5 MHz wide, and a second channel may be 20 MHz wide. If the modulation and coding, for example, are common between the channels, when the radio switches from the second channel at 20 MHz width to the first channel at 5 MHz width, among other contemplated conditions, the master clock may be slow down to ¼ of the original clock rate. If the modulation and coding, for example, are common between the channels, when the radio switches from the first channel to the second channel, the master clock may be sped up by a factor of 4 (e.g., 4 times as fast as the clock rate before the switching). In one or more embodiments, the changing of the clock rate may be dynamic depending on the spectrum availability and the channel qualities. The parameters related to timing, such as Short Interframe Space (SIFS) and/or DCF Interframe Space (DIFS), may be controlled by the master clock to maintain the proper behavior at the protocol level. For example, the clock counters may be adjusted for these parameters so that the values of the parameters comply with any standards.

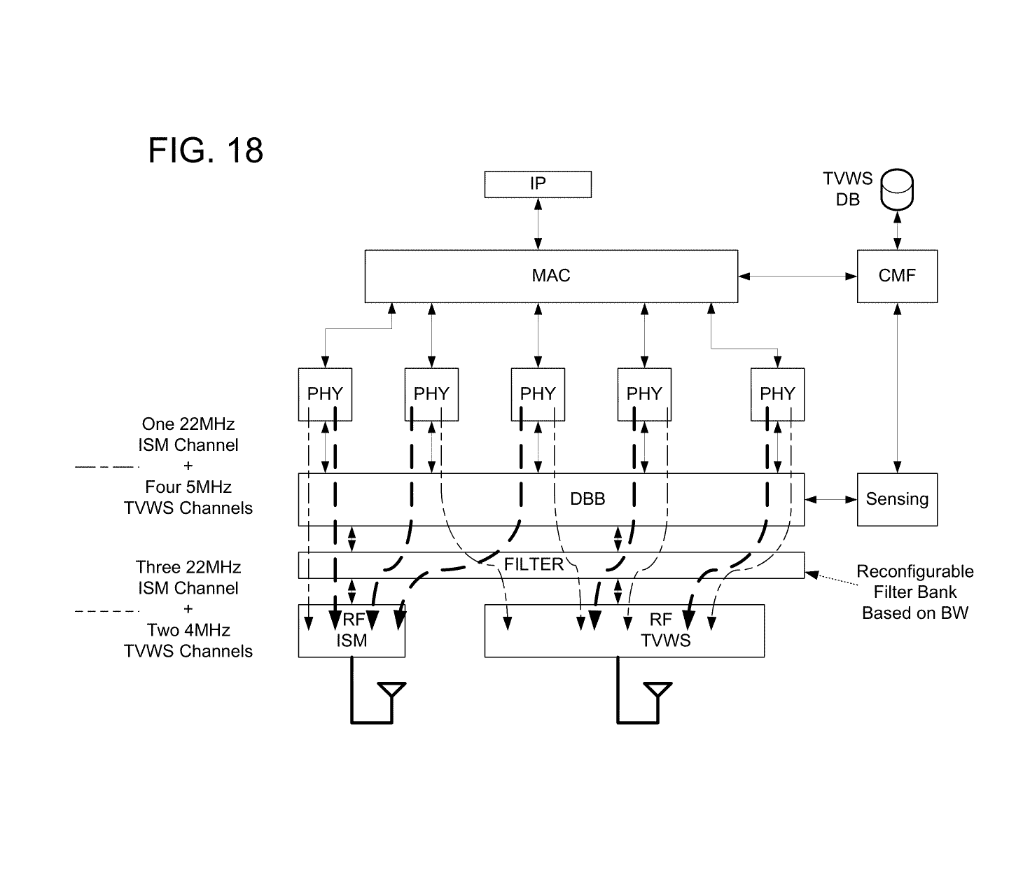

FIG. 18 is a block diagram illustrating an exemplary transceiver architecture for inter-band MAC-layer aggregation (e.g., using multiple radio front-ends).

Referring to FIG. 18, the transceiver architecture may include a first radio front-end and a second radio front-end, a filter module, a digital baseband (DBB) module, a plurality of PHY layers/modules, a MAC layer and an IP layer. The transceiver may realize inter-band MAC-layer aggregation using the two radio front ends including the first radio front end (e.g., for the ISM band) and the second radio front end (e.g., for the TVWS band). In FIG. 18, the transceiver is shown for a 5-band aggregation scheme, but aggregation scheme of any number of bands is possible. The 5-band aggregation scheme may include 5 independent PHY chains mapped to the two RF front ends. A first flow may include three 22 MHz ISM channels aggregated with two 5 MHz TVWS channels. A second flow may include one 22 MHz ISM channel aggregated with four 22 MHz TVWS channels. One of the bands (e.g., ISM or TVWS) may act, as an anchor carrier, while the other band or bands may act, as a supplementary or secondary carrier. The anchor channel may carry the control information for channel allocation, and/or link establishment and removal on the supplementary or secondary carrier or carriers. The aggregation of the first and second flows may occur at the MAC layer from the lower PHY layers.

The MAC layer (e.g., a single common MAC layer) may schedule the IP packets to different PHY flows using a joint scheduler. The flow control mechanism may be implemented based on the channel quality feedback received from the individual PHY layers back to the MAC layer.

The filter module may include a tunable RF filter bank having a bandwidth that may be set dynamically based on the availability of spectrum on the band. For example, each filter in the filter bank may be set to either 22 MHz on the ISM band or 5 MHz on the TVWS band. The DBB module may be configured for dynamic up conversion from baseband to passband of a signal or dynamic down conversion from passband to baseband of the signal. The DDB may be used to collect raw digital samples from the RF front end to provide to a sensing module or processor.

The sensing module may communicate with the CMF, which may in turn communicate with the TVWS database.

The channels on the ISM band and the TVWS band may be allocated based on channel availability and/or channel quality results from the sensing module. In one or more embodiments, the allocation may be based additionally on information from the TVWS database for the TVWS band) indicating allowable and/or restricted channel availability.

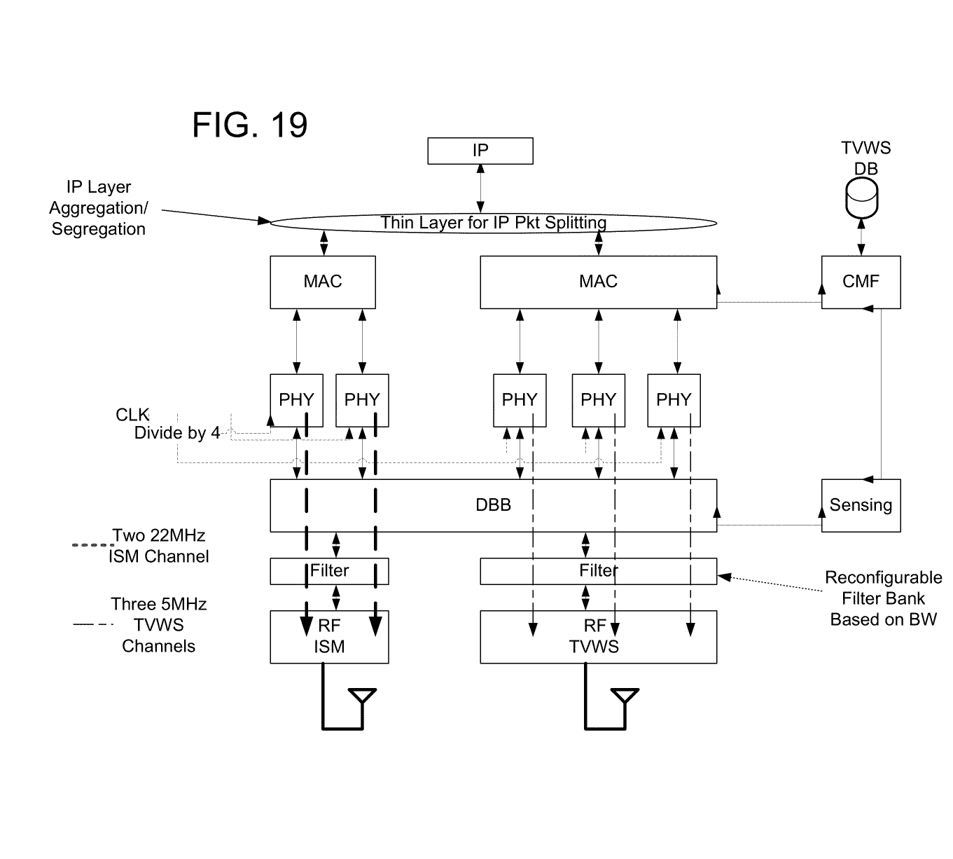

FIG. 19 is a block diagram illustrating another representative transceiver architecture.

Referring to FIG. 19, the transceiver may be configured similar to that of FIG. 18 except that the PHY layers may be mapped directly to either the ISM or TVWS radio front ends. For example, three of the PHY layers may be mapped to the TVWS radio front end and two other PHY layers may be mapped to the ISM radio font-end.

In one or more embodiments, multiple bands may be aggregated using interband aggregation at the IP layer and intraband aggregation at the MAC layer. A thin layer above the MAC layer and below the IP layer may be configured for IP packet aggregation/segregation of UL and DL traffic. Individual MACs (e.g., one for each of the ISM and TVWS bands) may be configured for intra-band aggregation.

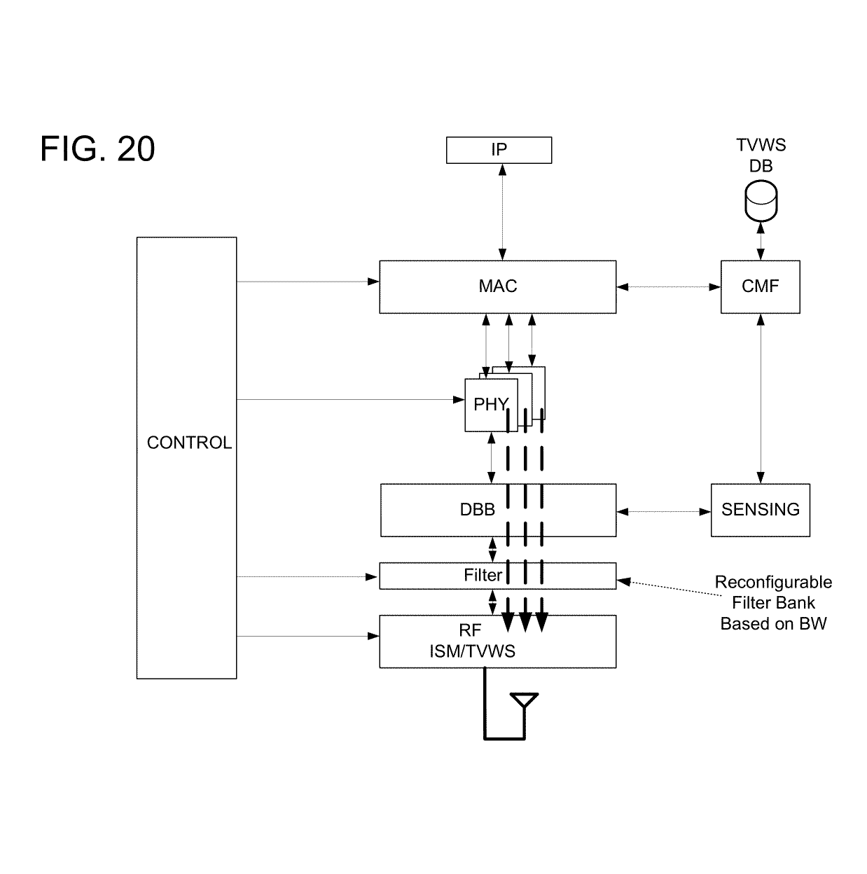

FIG. 20 is a block diagram illustrating another representative transceiver architecture.

Referring to FIG. 20, the transceiver may be configured similar to that of FIG. 19 except that a single wideband radio front-end (e.g., a single ISM/TVWS band radio front end) may be included and each PHY layer may be mapped directly to the single radio-front end to enable a flexible/tunable architecture may be used to achieve inter and intra band aggregation at the MAC layer and/or the IP layer. The tunability control may be managed using a control plane module. The control plane module may control the selection of one or both of: (1) IP layer aggregation, or (2) MAC layer aggregation and may also control the number of PHY flows, filter bank tuning, and/or RF band(s).

In view of the description herein and FIGS. 1-20, embodiments contemplate one or more techniques and/or wireless transmit/receive units (WTRU) for managing aggregation between an access point (AP) and a Wireless Receiver/Transmitter Unit (WRTU) using an anchor channel over a first frequency band between the AP and the WRTU, where the first frequency band may be an anchor band. The techniques and/or WTRU configuration may include wirelessly receiving, by the WRTU, one or more beacons via the anchor channel, where the one or more beacons may provide allocation information for allocating a supplementary channel on a second frequency band, as a supplementary band, that may be different from the first frequency band.

The techniques and/or WTRU configuration may also include establishing the supplementary channel over the supplementary band using the allocation information provided in the one or more beacons and/or wirelessly exchanging, by the WRTU, data over the established supplementary channel on the supplementary band.

The techniques and/or WTRU configuration may be such that the wirelessly exchanging of the data over the established supplementary channel may include one or more of: (1) wirelessly sending the data over the established supplementary channel; (2) wirelessly receiving the data over the established supplementary channel; and/or (3) wirelessly sending and receiving data over the established supplementary channel.

The techniques and/or WTRU configuration may be such that the wirelessly receiving of the one or more beacons via the anchor channel may include receiving a series of beacons, where each beacon may include control information for the anchor channel and control information for the supplementary channel.

The techniques and/or WTRU configuration may be such that the wirelessly receiving of the one or more beacons via the anchor channel may include receiving a series of beacons, where a first portion of the series of beacons may include control information for the anchor channel and a second portion of the series of beacons may include control information for the supplementary channel.

The techniques and/or WTRU configuration may be such that the series of beacons may be received in each beacon transmission interval such that the first beacon in each beacon transmission interval may be broadcast and other respective beacons in each beacon transmission interval may be multicast.

The techniques and/or WTRU configuration may be such that the series of beacons may be periodically received such that the first beacon associated with the anchor channel may be broadcast and other respective beacons associated with the supplementary channels may be multicast.

The techniques and/or WTRU configuration may also include determining, by the WRTU, which of the series of beacons are the beacons that include the control information for the supplementary channel based on a predetermined number of beacon intervals, and/or searching, by the WRTU, for the control information in the determined beacons.

The techniques and/or WTRU configuration may be such that the wirelessly receiving of the one or more beacons via the anchor channel may include providing allocation information for allocating at least one further supplementary channel on the second frequency band or a further frequency band. The techniques and/or WTRU configuration may also include establishing the further supplementary channel using the allocation information provided by the one or more beacons and/or wirelessly exchanging, by the WRTU, further data over the further supplementary channel.

The techniques and/or WTRU configuration may be such that the wirelessly exchanging of the data over the established supplementary channel and the further data over the further supplementary channel may include one or more of: (1) wirelessly sending the data over the established supplementary channel and wirelessly receiving the further data over the established further supplementary channel; (2) wirelessly receiving the data over the established supplementary channel and wireless sending the further data over the established further supplementary channel; (3) wirelessly sending the data and the further data over the established supplementary channel and the established further supplementary channel; and/or (4) wirelessly receiving the data and the further data over the established supplementary channel and the established further supplementary channel.

The techniques and/or WTRU configuration may be such that the wirelessly receiving of the one or more beacons via the anchor channel may include receiving a series of beacons, where a first portion of the series of beacons may include control information for the anchor channel and a second portion of the series of beacons may include control information for the supplementary channel.

The techniques and/or WTRU configuration may also include determining, by the WRTU from the control information in the second portion of the series of beacons, whether to modify channel allocation for sending/receiving data on at least one of: (1) the supplementary channel; and/or (2) the further supplementary channel. The techniques and/or WTRU configuration may also include changing, based on the control information in each beacon of the second portion of beacons, an allocation on the supplementary channel to provide one or more of: (1) an uplink only channel on the supplementary channel; and/or (2) a downlink only channel on the supplementary channel.

The techniques and/or WTRU configuration may also include changing, based on the control information in each beacon of the second portion of the beacons, an allocation on the further supplementary channel to provide one or more of: (1) an uplink only channel on the further supplementary channel; and/or (2) a downlink only channel on the further supplementary channel.

The techniques and/or WTRU configuration may also include switching the anchor channel and one channel of the supplementary channel and further supplementary channel, responsive to the one channel having less beacon losses relative to the anchor channel such that the one channel may become a new anchor channel and the previous anchor channel may become one of the supplementary channels.

The techniques and/or WTRU configuration may be such that the anchor channel may be in an ISM band and the supplementary band may be in a TVWS band.

The techniques and/or WTRU configuration may be such that the beacons that include the allocation information for the supplementary channel may further include quieting information indicating one or more quiet periods for quieting the WRTU.

The techniques and/or WTRU configuration may also include determining, by the WRTU, from the quieting information of the quiet periods and/or restricting, by the WRTU, transmissions during the quiet periods that may enable a search for other transmissions on the TVWS band.

The techniques and/or WTRU configuration may also include responsive to finding other transmissions on the TVWS band, receiving, by the WRTU, one or more beacons indicating updated allocation information to move the WRTU from the supplementary channel.

The techniques and/or WTRU configuration may be such that the allocation information in the beacons sent over on the anchor channel may include operating information regarding the supplementary channel associated with at least one of: (1) an association procedure; and/or (2) a discovery procedure.

The techniques and/or WTRU configuration may be such that the wirelessly receiving of the one or more beacons via the anchor channel may include one or more of: detecting at least one beacon in a beacon portion of a frame that is associated with control information indicating the allocation information for the anchor channel; and/or detecting a beacon in a payload portion of the frame used for data exchange on the anchor channel, where the beacons detected in the payload portion may indicate the allocation information for the supplementary channel.

The techniques and/or WTRU configuration may include detecting the allocation information from the received one or more beacons including determining at least one of: (1) a usage mode of the supplementary channel; (2) activation or deactivation of the supplementary channel; (3) a traffic indication map indicating whether the WRTU is scheduled for uplink or downlink transmission on the supplementary channel before the next beacon interval; (4) a resource sharing map indicating whether the WRTU is restricted from using the supplementary channel for the current beacon interval; (5) dynamic spectrum management information indicating at least one of (i) a quieting period during which the WRTU is restricted from transmitting over the supplementary channel, (ii) transmitted power limits for the supplementary channel, or (iii) coexistence information; (6) a channel switch announcement; and/or (7) a beacon interval number identifying a particular beacon interval.

The techniques and/or WTRU configuration may also include sending, by the WRTU, a request including capability information indicating the capability of the WRTU to use the supplementary channel or further supplementary channels.

The techniques and/or WTRU configuration may also include receiving, by the WRTU via the anchor channel, at least one of: a scaling factor indicating a channel synchronization relative to the anchor channel and/or a secondary channel sync signal in a management frame on the anchor channel.

The techniques and/or WTRU configuration may also include receiving, by the WRTU via the supplementary channel, frames including data; and/or sending, by the WRTU via the anchor channel, a block acknowledgement for the frames received on the supplementary channel.

The techniques and/or WTRU configuration may be such that the sending of the block acknowledgement for the frames received on the supplementary channel may be sent responsive to expiration of a timer or the initiation of a subsequent beacon interval.

The techniques and/or WTRU configuration may be such that the sending of the block acknowledgement for the frames received on the supplementary channel may be sent when a time since reception of the oldest unacknowledged frame exceeds a threshold.

The techniques and/or WTRU configuration may also include receiving, by the WRTU, a broadcast acknowledgement query on the anchor channel to initiate a block acknowledgment response, wherein responsive to reception of the broadcast acknowledgement query, the block acknowledgement on the anchor channel for the frames received on the supplementary channel may be sent.

The techniques and/or WTRU configuration may also include receiving, by the WRTU, a broadcast acknowledgement query on the anchor channel to initiate a block acknowledgment response, wherein responsive to reception of the broadcast acknowledgement query, the block acknowledgement on the anchor channel for the frames received on the supplementary channel may be sent.

The techniques and/or WTRU configuration may also include determining, by the WRTU whether predetermined portions used for data exchange on the anchor channel may be available for acknowledgements; and/or inserting, by the WRTU, the block acknowledgment into one of the predetermined portions that is available for acknowledgements, where the sending of the block acknowledgement for the frames received on the supplementary channel may include sending the frame that includes the inserted block acknowledgment.

The techniques and/or WTRU configuration may be such that the WRTU may be a plurality of WRTUs. The techniques and/or WTRU configuration(s) may also include: allocating the supplementary channel based on one or more of: (1) a fixed reservation-access scheme in which supplementary channel is shared between or among the plurality of WRTUs in a fixed round-robin manner; (2) a demand reservation-based access scheme in which the anchor channel is used as a reservation channel; and/or (3) a contention access scheme in which each WRTU follows pre-existing rules for sensing the supplementary channel and transmits if the channel is sensed free for a threshold period.

Embodiments contemplate techniques and/or access point (AP) configuration for managing aggregation between an access point (AP) and a Wireless Receiver/Transmitter Unit (WRTU) using an anchor channel over a first frequency band between the AP and the WRTU, where the first frequency band may be an anchor band. The techniques and/or AP configuration may include wirelessly transmitting, by the AP, one or more beacons via the anchor channel, where the one or more beacons may provide allocation information for allocating a supplementary channel on a second frequency band, as a supplementary band, different from the first frequency band.

The techniques and/or AP configuration may include establishing the supplementary channel over the supplementary band using the allocation information provided by the one or more beacons, and/or wirelessly exchanging, by the AP, data over the established supplementary channel on the supplementary band.

The techniques and/or AP configuration may be such that the wirelessly exchanging of the data over the established supplementary channel may include one of: (1) wirelessly sending the data over the established supplementary channel; (2) wirelessly receiving the data over the established supplementary channel; and/or (3) wirelessly sending and receiving data over the established supplementary channel.

The techniques and/or AP configuration may be such that the wirelessly sending of the one or more beacons via the anchor channel may include sending a series of beacons, where each beacon may include control information for the anchor channel and control information for the supplementary channel.

The techniques and/or AP configuration may be such that the wirelessly sending of the one or more beacons via the anchor channel may include sending a series of beacons, where a first portion of the series of beacons may include control information for the anchor channel and a second portion of the series of beacons may include control information for the supplementary channel.

The techniques and/or AP configuration may also include determining, by the AP, which of the series of beacons may be the beacons that are to include the control information for the supplementary channel based on a predetermined number of beacon intervals, and/or inserting, by the AP, the control information in the determined beacons.

The techniques and/or AP configuration may be such that the series of beacons may be sent in each beacon transmission interval such that the first beacon in each beacon transmission interval may be broadcast and other respective beacons in each interval may be multicast.

The techniques and/or AP configuration may be such that the series of beacons may be periodically sent such that the first beacon associated with the anchor channel may be broadcast and other respective beacons associated with the supplementary channels may be multicast.

The techniques and/or AP configuration may be such that the wirelessly sending of the one or more beacons via the anchor channel may include providing allocation information for allocating at least one further supplementary channel on a further frequency band, as a further supplementary band, different from the anchor or supplementary bands. The techniques and/or AP configuration may also include establishing the further supplementary channel over the further supplementary band using the allocation information provided by the one or more beacons, and/or wirelessly exchanging, by the WRTU, further data over the further supplementary channel on the further supplementary band.

The techniques and/or AP configuration may be such that the wirelessly exchanging of the data over the established supplementary channel and the further data over the further supplementary channel includes one or more of: (1) wirelessly sending the data over the established supplementary channel and wirelessly receiving the further data over the established further supplementary channel; (2) wirelessly receiving the data over the established supplementary channel and wireless sending the further data over the established further supplementary channel; (3) wirelessly sending the data and the further data over the established supplementary channel and the established further supplementary channel; and/or (4) wirelessly receiving the data and the further data over the established supplementary channel and the established further supplementary channel.

The techniques and/or AP configuration may be such that the wirelessly sending of the one or more beacons via the anchor channel may include sending a series of beacons, a first portion of the series of beacons that may include control information for the anchor channel and a second portion of the series of beacons that may include control information for the supplementary channel.

The techniques and/or AP configuration may also include determining, by the AP, whether to modify one or more channel allocations for exchanging data on the supplementary and further supplementary channels, and/or inserting, by the AP into the second portion of the series of beacons, control information to allocate the supplementary channel as one or more of: (1) as an uplink only channel; and/or (2) a downlink only channel. The techniques and/or AP configuration may also include inserting, by the AP into the second portion of the series of beacons, control information to allocate the further supplementary channel as one of: (1) as an uplink only channel; or (2) a downlink only channel; and/or sending, by the AP, the series of beacons on the anchor channel.

The techniques and/or AP configuration may also include switching, by the AP, the anchor channel and one channel of the supplementary channel and the further supplementary channel, responsive to the one channel having less beacon losses relative to the anchor channel such that the one channel may become a new anchor channel and the previous anchor channel may become one of the supplementary channels.

The techniques and/or AP configuration may be such that the anchor channel may be in an ISM band and the supplementary band may be in a TVWS band.

The techniques and/or AP configuration may be such that the beacons that include the allocation information of the supplementary channel may further include quieting information indicating one or more quiet periods for quieting the WRTU. The techniques and/or AP configuration may also include determining, by the AP during the one or more quiet periods, whether transmissions are present on the TVWS band, as a determined result, and/or sending, by the AP to the WRTU, updated allocation information, responsive to the determined result.

The techniques and/or AP configuration may be such that the allocation information in the beacons on the anchor channel may include operating information regarding the supplementary channel associated with at least one of: (1) an association procedure; and/or (2) a discovery procedure.

The techniques and/or AP configuration may be such that the wirelessly sending of the one or more beacons via the anchor channel may include: sending at least one beacon in a beacon portion that is associated with control information indicating the allocation information for the anchor channel; and/or sending one or more beacons in a payload portion used for data exchange on the anchor channel, where the beacons sent in the payload portion may indicate the allocation information for the supplementary channel.

The techniques and/or AP configuration may also include: inserting the allocation information into the one or more beacons to be sent including determining at least one of: (1) a usage mode of the supplementary channel; (2) activation or deactivation of the supplementary channel; (3) a traffic indication map indicating whether the WRTU is scheduled for uplink or downlink transmission on the supplementary channel before the next beacon interval; (4) a resource sharing map indicating whether the WRTU is restricted from using the supplementary channel for the current beacon interval; (5) dynamic spectrum management information indicating at least one of (i) a quieting period during which the WRTU is restricted from transmitting over the supplementary channel, (ii) transmitted power limits for the supplementary channel, or (iii) coexistence information; (6) a channel switch announcement; and/or (7) a beacon interval number identifying a particular beacon interval, as the allocation information.

The techniques and/or AP configuration may also include receiving, by the AP, a message including capability information indicating the capability of the WRTU to use the supplementary channel or further supplementary channels; determining, by the AP, an allocation of at least one of: (1) the supplementary channel and/or (2) the further supplementary channels for the WRTU in accordance with the received capability information; and/or inserting the allocation information corresponding to the determined allocation for the WRTU in the series of beacons destined for the WRTU.

The techniques and/or AP configuration may also include sending, by the WRTU via the anchor channel, at least one of: a scaling factor indicating channel synchronization relative to the anchor channel, and/or a secondary channel sync signal in a management frame on the anchor channel.

The techniques and/or AP configuration may also include sending, by the AP via the supplementary channel, frames including data; and/or receiving, by the AP via the anchor channel, a block acknowledgement for the frames received on the supplementary channel.

The techniques and/or AP configuration may be such that the receiving of the block acknowledgement for the frames sent on the supplementary channel may be received in a same or a next beacon interval as the allocation of the supplementary channel for the data sent.

The techniques and/or AP configuration may be such that the receiving of the block acknowledgement for the frames sent on the supplementary channel may be received after a time since reception of the oldest unacknowledged frame exceeds a threshold.

The techniques and/or AP configuration may also include sending, by the AP, a broadcast acknowledgement query on the anchor channel to initiate a block acknowledgment response; and/or receiving, by the AP, the block acknowledgement in response to the broadcast acknowledgement query.

The techniques and/or AP configuration may also include detecting, by the AP, the block acknowledgement from one or more predetermined portions used for data exchange on the anchor channel; and/or resending one or more frames using a frame identify when the block acknowledgement indicates that the one or more frames were not properly received.

The techniques and/or AP configuration may be such that the WRTU is a plurality of WRTUs. The techniques and/or AP configuration may also include allocating, by the AP, the supplementary channel based on at least one of: (1) a fixed reservation-access scheme in which the supplementary channel is shared between or among the plurality of WRTUs in a fixed round-robin manner; (2) a demand reservation-based access scheme in which the anchor channel is used as a reservation channel; and/or (3) a contention access scheme in which each WRTU follows pre-existing rules for sensing the supplementary channel and transmits if the channel is sensed free for threshold period.

Embodiments contemplate techniques and/or WTRU configuration for managing band aggregation with an access point (AP) using an anchor channel over a first frequency band with the AP, where the first frequency band may be an anchor band. The techniques and/or WTRU configuration may include a wireless receiver/transmitter configured to wirelessly receive one or more beacons via the anchor channel, where the one or more beacons may provide allocation information for allocating of a supplementary channel on a second frequency band, as a supplementary band, different from the first frequency band; and/or a processor in communication with the wireless receiver/transmitter configured to establish the supplementary channel over the supplementary band using the allocation information provided by the one or more beacons.

The techniques and/or WTRU configuration may be such that the wireless receiver/transmitter may wirelessly exchange data over the established supplementary channel on the supplementary band.

The techniques and/or WTRU configuration may be such that a MAC layer may aggregate the flows over the anchor and supplementary channels.

Embodiments contemplate techniques and/or AP configuration that for managing band aggregation with a Wireless Receiver/Transmitter Unit (WRTU) using an anchor channel over a first frequency band with the WRTU, where the first frequency band being an anchor band. The techniques and/or AP configuration may include a wireless receiver/transmitter configured to wirelessly transmit one or more beacons via the anchor channel, the one or more beacons providing allocation information for allocating a supplementary channel on a second frequency band, as a supplementary band, different from the first frequency band; and/or a processor in conjunction with the wireless receiver/transmitter configured to establish the supplementary channel over the supplementary band using the allocation information provided by the one or more beacons.

The techniques and/or AP configuration may be such that the wireless receiver/transmitter may wirelessly exchange data over the established supplementary channel on the supplementary band.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

What is claimed is:

1. A wireless transmit/receive unit (WTRU), the WTRU in communication with an access point (AP) via an anchor channel over a first frequency band, the first frequency band being an anchor band, the WTRU configured at least in part to:
receive operating information via the anchor channel for a supplementary channel on a second frequency band, as a supplementary band, different from the first frequency band;
establish the supplementary channel over the supplementary band using the operating information; and
exchange data over the established supplementary channel on the supplementary band.

2. The WTRU of claim 1, the WTRU configuration further comprising receiving one or more beacons via the anchor channel, wherein the operating information is provided by the one or more beacons.

3. The WTRU of claim 1, the WTRU configuration further comprising receiving at least one anchor channel beacon, wherein the at least one anchor channel beacon includes the operating information in one or more information elements.

4. The WTRU of claim 2, wherein the receiving the one or more beacons via the anchor channel includes receiving a series of beacons, one or more of the series of beacons including control information for a respective series of supplementary channels.

5. The WTRU of claim 4, wherein the series of beacons are periodically received from the AP.

6. The WTRU of claim 1, wherein the operating information includes at least one of: a usage mode of the supplementary channel; activation or deactivation of the supplementary channel; an indication of whether the WRTU is scheduled for uplink or downlink transmission on the supplementary channel before a next beacon interval; an indication of whether the WRTU is restricted from using the supplementary channel for a current beacon interval; dynamic spectrum management information; a channel switch announcement; or a beacon interval number identifying a particular beacon interval.

7. The WTRU of claim 6, wherein the dynamic spectrum management information includes at least one of: a quieting period during which the WRTU is restricted from transmitting over the supplementary channel; transmitted power limits for the supplementary channel; or coexistence information.

8. The WTRU of claim 1, wherein the exchanging of the data over the established supplementary channel includes one of: sending the data over the established supplementary channel; receiving the data over the established supplementary channel; or sending and receiving data over the established supplementary channel.

9. The WTRU of claim 2, wherein the receiving the one or more beacons via the anchor channel includes receiving at least a first beacon received at a first periodicity and at least a second beacon received at a second periodicity, the at least first beacon including control information for the anchor channel and the at least second beacon including control information for the supplementary channel.

10. The WTRU of claim 9, wherein the at least the beacons are received such that the first beacon associated with the anchor channel is broadcast and the second series of beacons associated with the supplementary channels are multicast.

11. The WTRU of claim 1, wherein the anchor band is in an industrial, scientific, and medical (ISM) band and the supplementary band is in a television white space (TVWS) band.

12. The WTRU of claim 1, wherein the operating information provides for an allocation of the supplementary channel as a downlink only channel, and communication via the supplementary channel is reserved for at least one of frames not requiring acknowledgement, broadcast frames, or multicast frames.

13. The WTRU of claim 1, wherein the operating information provides for an allocation of the supplementary channel as an uplink only channel, and the WTRU configuration further comprises:
sending one or more reservations via the anchor channel for supplemental channel capacity;
receiving one or more assigned supplemental channel capacities in response to the one or more reservations; and
sending uplink data via the supplementary channel in one or more of the assigned supplemental channel capacities.

14. A method performed by a wireless transmit/receive unit (WTRU), the WTRU in communication with an access point (AP) via an anchor channel over a first frequency band, the first frequency band being an anchor band, the method comprising:
receiving operating information via the anchor channel for a supplementary channel on a second frequency band, as a supplementary band, different from the first frequency band;
establishing the supplementary channel over the supplementary band using the operating information; and
exchanging data over the established supplementary channel on the supplementary band.

15. The method of claim 14, the method further comprising receiving one or more beacons via the anchor channel, wherein the operating information is provided by the one or more beacons.

16. An access point (AP), the AP in communication with a wireless transmit/receive unit (WTRU), via an anchor channel over a first frequency band, the first frequency band being an anchor band, the AP configured at least in part to:
sending operating information via the anchor channel for a supplementary channel on a secondary frequency band, as a supplementary band, different from the first frequency band;
establish the supplementary channel over the supplementary band using the operating information; and
exchanging data over the established supplementary channel on the supplementary band.

17. The AP of claim 16, the AP configuration further comprising sending one or more beacons via the anchor channel, wherein the operating information is provided by the one or more beacons.

18. The AP of claim 17, wherein the sending of the one or more beacons via the anchor channel includes providing additional operating information for at least one additional supplementary channel on a further frequency band, as an additional supplementary band, different from the anchor or supplementary bands, the AP configuration further comprising:
establish the additional supplementary channel over the additional supplementary band using the additional operating information provided by the one or more beacons; and
exchanging additional data over the additional supplementary channel on the additional supplementary band.

19. The AP of claim 18, wherein the sending the one or more beacons via the anchor channel includes sending a first series of beacons and a second series of beacons, the first series of beacons including control information for the anchor channel and the second series of beacons including control information for the supplementary channel and the additional supplementary channel, wherein the AP configuration further comprises:
determining whether to modify one or more channel allocations for exchanging data on the supplementary and the additional supplementary channels;
inserting into the second series of beacons, control information to allocate the supplementary channel as one of: an uplink only channel or a downlink only channel; and
inserting into the second series of beacons, control information to allocate the additional supplementary channel as one of: an uplink only channel or a downlink only channel.

20. The AP of claim 16, wherein the AP configuration further comprises:
sending via the supplementary channel, frames including data; and
receiving via the anchor channel, a block acknowledgement for the frames received on the supplementary channel.
